(19) United States
(12) Patent Application Publication
(10) Pub. No.: US 2025/0351122 A1
(43) Pub. Date: Nov. 13, 2025

(54) METHODS, PROCEDURES AND APPARATUS FOR RESOURCE ALLOCATION OF DISTRIBUTED RESOURCE UNITS IN PUNCTURED CHANNELS IN WI-FI

(71) Applicant: InterDigital Patent Holdings Inc., Wilmington, DE (US)

(72) Inventors: Mahmoud Saad, Montreal (CA); Hanqing Lou, Syosset, NY (US); Ying Wang, Easton, PA (US); Rui Yang, Greenlawn, NY (US)

(73) Assignee: InterDigital Patent Holdings Inc., Wilmington, DE (US)

(21) Appl. No.: 18/659,808

(22) Filed: May 9, 2024

(51) Int. Cl. H04W 72/04

(52) U.S. Cl. CPC H04W 72/04

(57) ABSTRACT

In an example, a station (STA) receives, from an access point (AP), a trigger frame with a resource unit (RU) allocation field indicating a distributed RU (DRU) index value. Further, the STA determines, based on the indicated DRU index value, a DRU allocation from a plurality of DRU allocations. Each of the plurality of DRU allocations includes a respective tone distribution plan. Further, tones of the determine DRU allocation and the respective tone distribution plan are interleaved with tones of one or more other tone distribution plans, of the plurality of tone distribution plans, across a distribution bandwidth. The STA then transmits, to the AP, a plurality of tones using a DRU within the distribution bandwidth, based on the determine DRU allocation and the respective tone distribution plan. In a further example, the trigger frame may include information indicating the distribution bandwidth.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

The traffic between STAs within a BSS may be considered as or referred to as peer-to-peer traffic. The peer-to-peer traffic may be sent between, for example, directly between, the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP; and the STAs, for example, all of the STAs, within or using the IBSS may communicate directly with each other. The IBSS mode of communication may sometimes be referred to herein as an “ad-hoc” mode of communication.

Using the 802.11ac infrastructure mode of operation, the AP may transmit a beacon on a fixed channel, usually the primary channel. This channel may be 20 megahertz (MHZ) wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel. In 802.11ac, VHT STAs may support 20 MHz, 40 MHZ, 80 MHZ, and 160 MHz wide channels.

### SUMMARY

In an example, a station (STA) receives, from an access point (AP), a trigger frame with a resource unit (RU) allocation field indicating a distributed RU (DRU) index value. Further, the STA determines, based on the indicated DRU index value, a DRU allocation from a plurality of DRU allocations. Each of the plurality of DRU allocations includes a respective tone distribution plan. Further, tones of the determine DRU allocation and the respective tone distribution plan are interleaved with tones of one or more other tone distribution plans, of the plurality of tone distribution plans, across a distribution bandwidth. The STA then transmits, to the AP, a plurality of tones using a DRU within the distribution bandwidth, based on the determine DRU allocation and the respective tone distribution plan.

In a further example, the trigger frame may include information indicating the distribution bandwidth. Moreover, the determination by the STA of the DRU allocation may be further based on the indicated distribution bandwidth.

Further, the plurality of tones may be transmitted over a plurality of RUs, in an example. Also, the determined DRU allocation may further include the distribution bandwidth. In another example, the determined DRU allocation and respective subcarrier tone distribution plan may further include a distribution of subcarrier tones in regions outside of punctured subchannels within a channel. In a further example, the STA may determine the DRU size based on the DRU index value. Additionally or alternatively, the STA may determine the DRU size based on the RU allocation field. Further, the STA may determine the DRU allocation further based on the DRU size as well as the DRU index value. Additionally or alternatively, the STA may determine the distribution bandwidth based on the DRU size.

Additionally or alternatively, the RU allocation field may be received in a User Info field of the trigger frame. Additionally or alternatively, the AP may transmit, and the STA may receive, the RU allocation field in a ultra-high reliability (UHR)-SIG field of a physical layer (PHY) protocol data unit (PDU) (PPDU). Additionally or alternatively, the RU allocation field may be received in a control information sub-field in a triggered response scheduling (TRS) control field of a PPDU.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a frame format diagram illustrating an example of an high efficiency (HE) variant Common Info field format in a trigger frame;

FIG. 2B is a frame format diagram illustrating an example of an extremely high throughput (EHT) variant Common Info field format in a trigger frame;

FIG. 2C is a frame format diagram illustrating an example of a Special User Info field;

FIG. 3 is a frame format diagram illustrating an example of an HE variant User Info field format and an EHT variant User Info field format in a trigger frame;

FIG. 4 is a transmission diagram illustrating a general example of a distributed-tone resource unit (DRU) over a distribution bandwidth;

FIG. 5 is a tone plan diagram illustrating an example of a tone plan for 26DRU20;

FIG. 6 is a tone plan diagram illustrating an example of a tone plan for 26DRU40;

FIG. 7 is a signaling diagram illustrating an example of a resource allocation for one or more DRUs;

FIG. 8 is a channel diagram illustrating an example of a punctured 80 MHz channel;

FIG. 9 is a channel diagram illustrating an example of all combinations of a punctured 80 MHz channel;

FIG. 10 is a channel diagram illustrating an example of a determination of the distribution bandwidth in a punctured 80 MHz channel;

FIG. 11 is a table diagram listing an example of the corresponding distribution bandwidths for different puncturing patterns in an 80 MHz channel;

FIG. 12 is a channel diagram illustrating an example of a determination of the distribution bandwidth in a punctured 160 MHz channel;

FIG. 13A is a table diagram listing an example of the corresponding distribution bandwidths for different puncturing patterns in a 160 MHz channel;

FIG. 13B is a table diagram listing an example of the corresponding distribution bandwidths for different puncturing patterns in a 160 MHz channel (FIG. 13A and FIG. 13B are collectively referred to herein as FIG. 13);

FIG. 14 is a channel diagram illustrating an example of a determination of the distribution bandwidth in a punctured 320 MHz channel;

FIG. 15A is a table diagram listing an example of the corresponding distribution bandwidths for different puncturing patterns in a 320 MHz channel;

FIG. 15B is a table diagram listing an example of the corresponding distribution bandwidths for different puncturing patterns in a 320 MHz channel; and

FIG. 15C is a table diagram listing an example of the corresponding distribution bandwidths for different puncturing patterns in a 320 MHz channel (FIG. 15A, FIG. 15B, and FIG. 15C are collectively referred to herein as FIG. 15).

### DETAILED DESCRIPTION

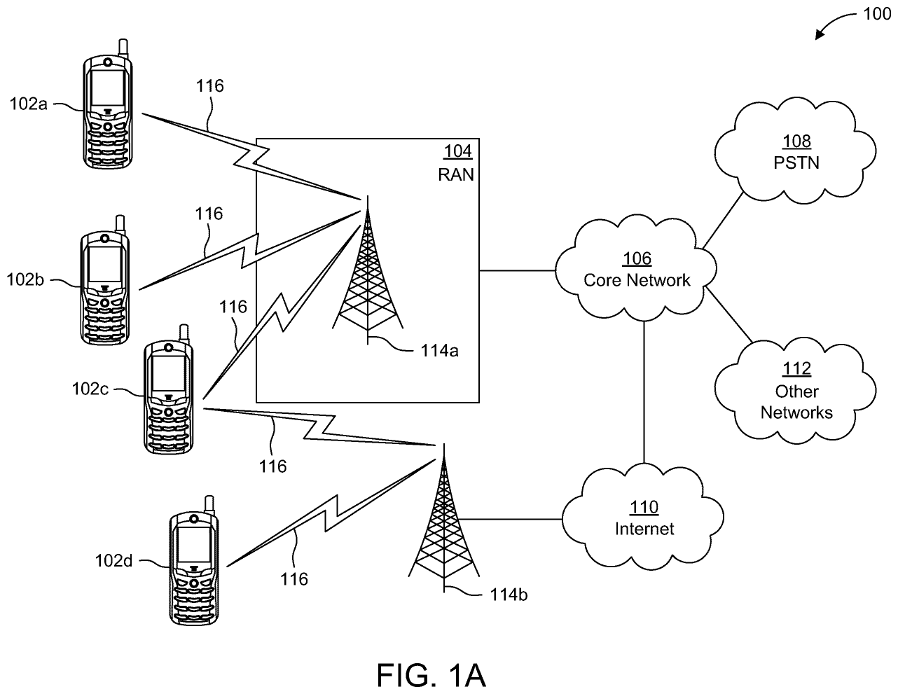

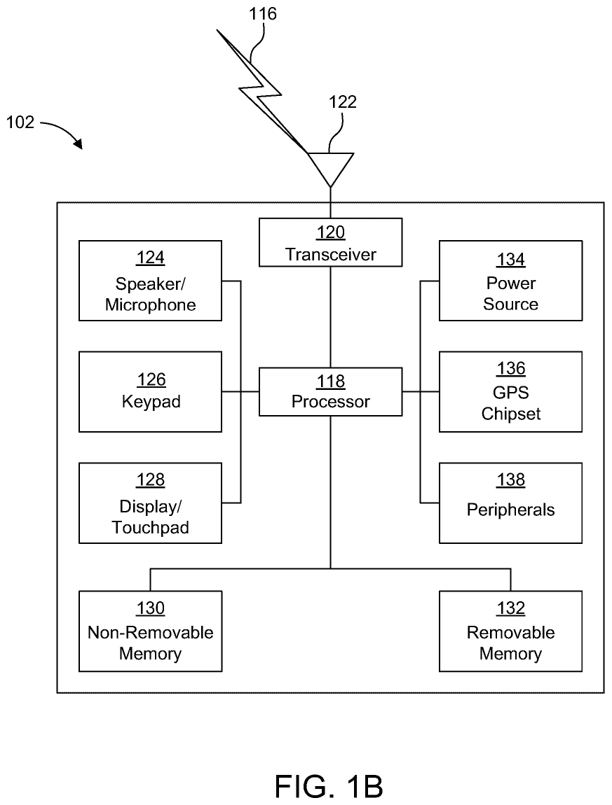

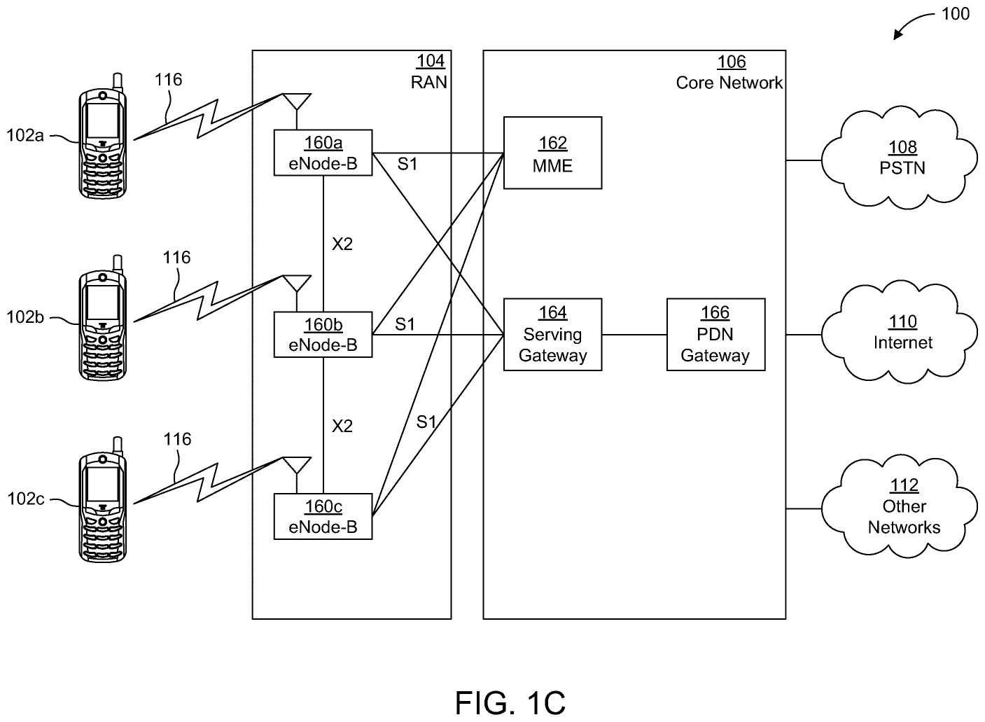

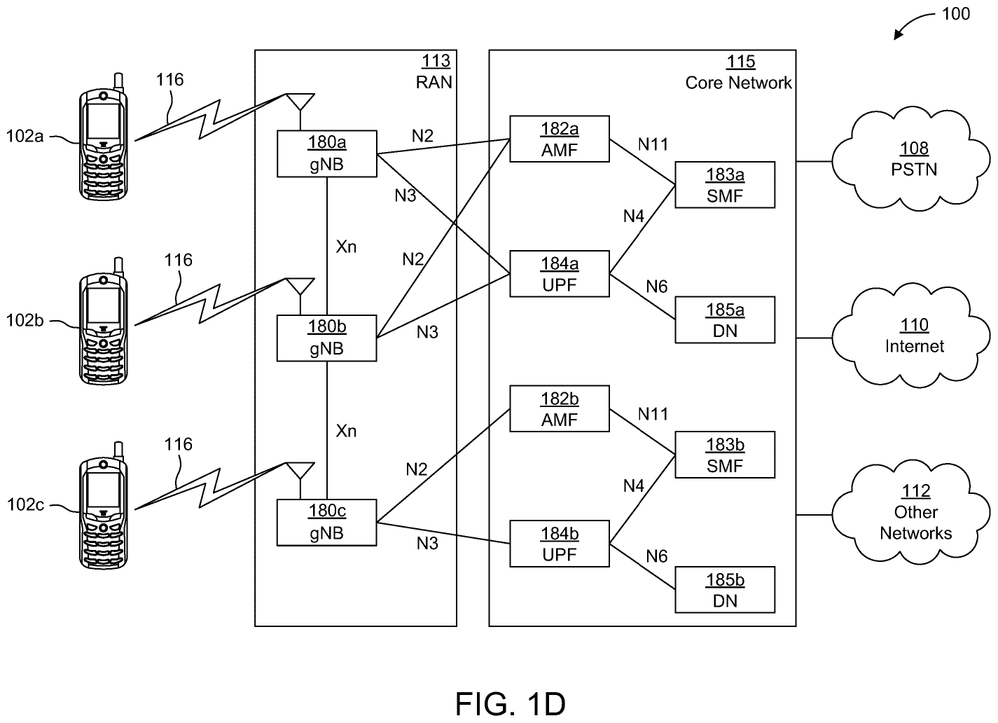

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device (e.g., gaming devices), a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or Wi-Fi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

An AP may transmit a beacon on a fixed channel, such as a primary channel. The primary channel may be a fixed width, for example, 20 megahertz (MHz) wide bandwidth, or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off for a certain period of time before sensing again. One STA (e.g., only one station) may transmit at any given space, time and frequency resource in a given BSS.

In other representative embodiments, an AP may assign bandwidth resources over which associated STAs communicate with the AP. Bandwidth resources may include one or more channels (i.e., contiguous, or non-contiguous), one or more subchannels within a channel, one or more resource units (RUs) within an Orthogonal Frequency division Multiple Access (OFDMA) system, whereby assigned one or more RUs may be adjacent (i.e., contiguous) or non-contiguous, occupying one or more channels or subchannels, etc.

High Throughput (HT or 802.11n) STAs may use a 40 MHz wide channel for communication, for example, via a combination of the primary 20 MHz channel with an adjacent or nonadjacent 20 MHz channel to form a 40 MHz wide channel.

Very High Throughput (VHT or 802.11ac) STAs may support 20 MHz, 40 MHZ, 80 MHZ, and/or 160 MHz wide channels transmitted over a 5 GHz frequency band using OFDMA. The 40 MHZ, and/or 80 MHZ, channels may be formed by combining contiguous 20 MHz channels. A 160 MHz channel may be formed by combining 8 contiguous 20 MHZ channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

High Efficiency Wireless (HEW or 802.11ax) STAs may support 20 MHz, 40 MHZ, 80 MHZ, and/or 160 MHz wide channels capable of transmission over 2.4 GHZ, 5 GHZ, and 6 GHz frequency bands using both OFDMA and multi-user multiple-input multiple-output (MU-MIMO) capabilities. OFDMA subcarrier modulation in HE STAs includes formats such as BPSK, QPSK, 16-QAM, 64-QAM, 256-QAM, 1024-QAM. The evolution of 802.11 to Extremely High Throughput (EHT) STAs extends to having 320 MHz wide channels.

While earlier generation 802.11 STAs (e.g., HEW or 802.11ax) could decide to transmit on one of the 2.4, 5.0, or 6 GHz bands, EHT STAs are further capable of multi-link operation (MLO), whereby data transmission between an EHT AP and non-AP STAs can occur over multiple bands simultaneously (e.g., 5 GHZ and 6 GHZ) thus increasing throughput and/or reliability. EHT STAs also benefit from a jump in QAM modulation from 1024-QAM to 4K-QAM, while enabling peak data rates of around 46 Gbps compared to the 9.6 Gbps capabilities of HEW STAs.

The next generation of 802.11 standard, 802.11bn (i.e., Ultra High Reliability-UHR) explores the possibility to improve reliability, support further reduced low latency traffic, further increase peak throughput, improved power saving capabilities and improve efficiency of the IEEE 802.11 network over HEW. These improvements are driven by technological advancements such as 360 immersive video, ultra-high-resolution streaming, online gaming, remote surgery, rapid expansion of Internet of Things (IoT), etc. Other 802.11 standard development examples are directed to areas such as: the application and management of artificial intelligence and machine learning (AIML) in WLANs, expanding WiFi communications into the millimeter-wave frequency band (integrated millimeter-wave-IMMW), energy harvesting based on of WiFi RF signals for facilitating WLAN communications of low-power IoT devices, and the randomization of MAC addresses in WLANs.

As described above, in 802.11n, HT STAs may also use a 40 MHz wide channel for communication. This is achieved by combining the primary 20 MHz channel, with an adjacent 20 MHz channel to form a 40 MHz wide contiguous channel.

In 802.11ac, VHT STAs may support 20 MHz, 40 MHZ, 80 MHZ, and 160 MHz wide channels. The 40 MHZ, and 80 MHZ, channels are formed by combining contiguous 20 MHz channels similar to 802.11n described above. A 160 MHz channel may be formed either by combining 8 contiguous 20 MHz channels, or by combining two non-contiguous 80 MHZ channels, which may also be referred to as an 80+80 configuration. For the 80+80 configuration, the data, after channel encoding, is passed through a segment parser that divides it into two streams. The Inverse Discrete Fourier Transformation (IDFT) operation and time-domain processing is done on each stream separately. The streams are then mapped on to the two channels, and the data is transmitted. At the receiver, this mechanism is reversed, and the combined data is sent to the MAC.

Sub 1 GHz modes of operation are supported by 802.11af, and 802.11ah. For these specifications the channel operating bandwidths, and carriers, are reduced relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, and 802.11ah, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g. MTC type devices) that only support a 1 MHz mode even if the AP, and other STAs in the BSS, may support a 2 MHZ, 4 MHz, 8 MHZ, 16 MHZ, or other channel bandwidth operating modes. All carrier sensing, and NAV settings, depend on the status of the primary channel; i.e., if the primary channel is busy, for example, due to a STA supporting only a 1 MHZ operating mode is transmitting to the AP, then the entire available frequency bands are considered busy even though majority of it stays idle and available.

In the United States, the available frequency bands which may be used by 802.11ah are from 902 MHz to 928 MHz. In Korea it is from 917.5 MHz to 923.5 MHz; and in Japan, it is from 916.5 MHz to 927.5 MHz. The total bandwidth available for 802.11ah is 6 MHz to 26 MHz depending on the country code.

The IEEE 802.11 Ultra High Reliability (UHR) Study Group was formed explore the possibility to improve reliability, support low latency traffic and further increase peak throughput and improve efficiency of the IEEE 802.11 networks. A distributed-tone resource unit (DRU) may be used in UHR communications.

Further, 802.11bn may use DRU transmission and support DRU for a trigger based (TB) physical layer (PHY) PDU (TB-PPDU) transmission where the DRU means a resource unit (RU) which consists of subcarriers spreading across a certain bandwidth. A DRU is allowed in a punctured UHR TB transmission. Also, 802.11bn may use a hierarchical pilot structure for DRU such that the pilot locations of a larger DRU is a subset of the superset of the pilot locations of smaller component DRUs within the same PPDU bandwidth (BW). The number of pilot tones for the same size DRU and regular RU (RRU) is the same where the RRU means the existing RU defined in 11ax and 11be. Moreover, 802.11bn may use a hybrid mode with DRUs and RRUs in UHR UL TB OFDMA transmissions where the minimum PPDU BW for hybrid mode may be determined.

Trigger frame was introduced firstly in 802.11ax. Extremely high throughput (EHT) supports greater bandwidth (BW), multiple resource unit (RU) allocation, an enhanced modulation and coding scheme (MCS), and a greater number of spatial streams. 802.11be modified the Trigger frame so that it supports 802.11be new features, and meanwhile is backward compatible with 802.11ax. The trigger frame is used to allocate resources, and trigger single user access or multi-user access. A trigger frame format defined in 802.11ax is shown in Table 1, below. 802.11be reuses the same format for the Trigger frame.

TABLE 1
Trigger frame format in 802.11ax

| | Field: | | | | | | | | | |
|---|---|---|---|---|---|---|---|---|---|---|
| | Frame | | | | Common | User | | User | | |
| | Control | Duration | RA | TA | Info | Info | . . . | Info | Padding | FCS |
| Octets: | 2 | 2 | 6 | 6 | 8 or | 5 or | | 5 or | v | 4 |
| | | | | | more | more | | more | | |

The Common Info field in 802.11be has two variants, the high efficiency (HE) variant and the EHT variant.

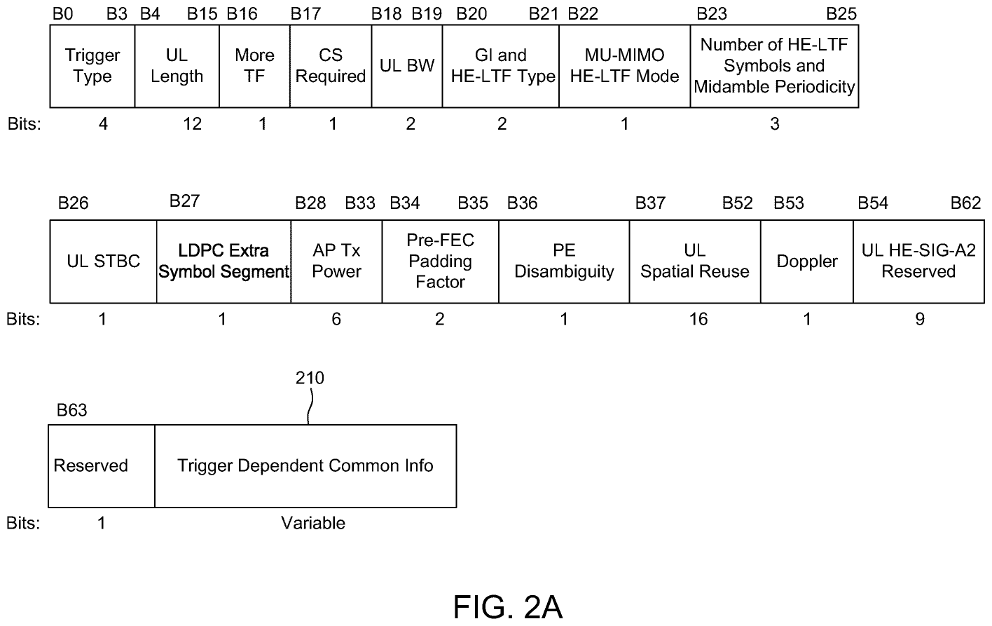

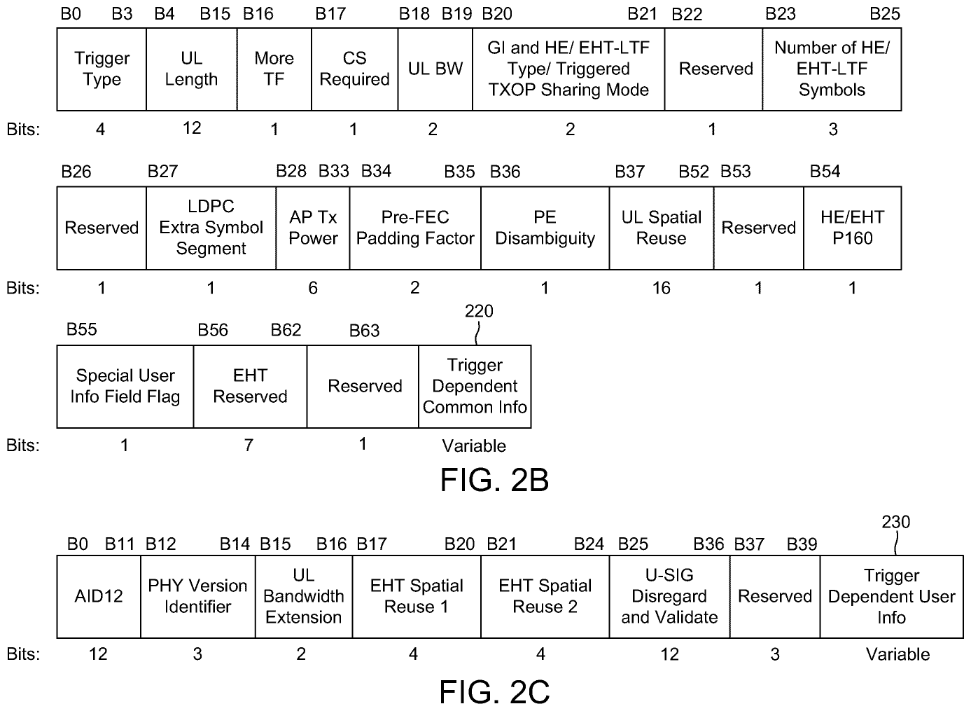

FIG. 2A is a frame format diagram illustrating an example of an HE variant Common Info field format in a trigger frame. As shown in an example in FIG. 2A, the Trigger Dependent Common Info subfield 210 may be of variable bit length. The bit lengths of the other subfields in the HE variant Common Info field format may be as shown in FIG. 2A.

FIG. 2B is a frame format diagram illustrating an example of an EHT variant Common Info field format in a trigger frame. As shown in an example in FIG. 2B, the Trigger Dependent Common Info subfield 220 may be of variable bit length. The bit lengths of the other subfields in the EHT variant Common Info field format may be as shown in FIG. 2B.

Further, there are three types of User Info fields defined in 802.11be: the Special User Info field, the HE variant User Info field and the EHT variant User Info field. The Special User Info field carries extended common information for EHT STAs to transmit a EHT TB-PPDU.

FIG. 2C is a frame format diagram illustrating an example of a Special User Info field. As shown in an example in FIG. 2C, the Trigger Dependent User Info subfield 230 may be of variable bit length. The bit lengths of the other subfields in the Special User Info field may be as shown in FIG. 2C.

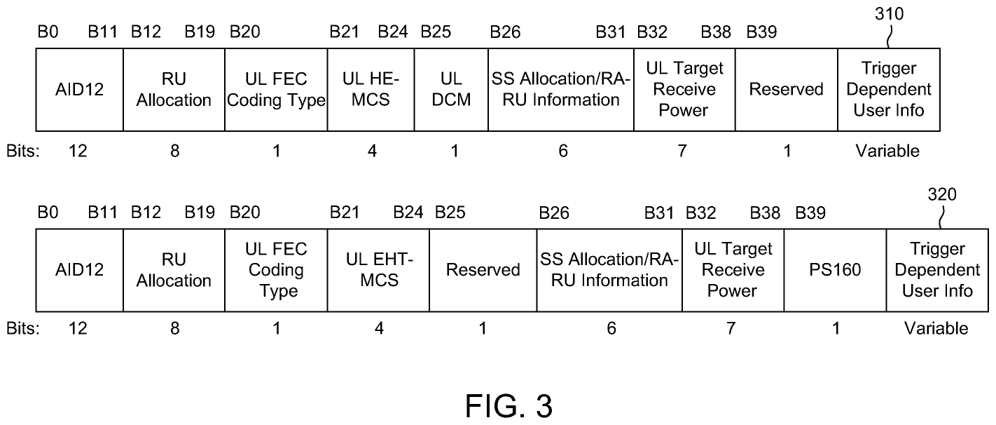

FIG. 3 is a frame format diagram illustrating an example of an HE variant User Info field format and an EHT variant User Info field format in a trigger frame. The HE variant User Info field for all trigger types except Null Feedback Report Poll (NFRP) trigger is defined in the top part of FIG. 3. As shown in an example in FIG. 3, the Trigger Dependent User Info subfield 310 of the HE variant User Info field format may be of variable length. The bit lengths of the other subfields in the HE variant User Info field format may be as shown in FIG. 3.

Also, the EHT variant User Info field for all trigger types except NFRP trigger is defined in the bottom part of FIG. 3. As shown in an example in FIG. 3, the Trigger Dependent User Info subfield 320 of the EHT variant User Info field format may be of variable length. The bit lengths of the other subfields in the EHT variant User Info field format may be as shown in FIG. 3.

The trigger type subfield in Common Info field (such as in FIG. 2A or FIG. 2B), in the trigger frame format shown in Table 1, has possible values as shown in Table 2, below.

TABLE 2
Trigger Type

| Trigger Type | |
|---|---|
| Subfield value | Trigger frame variant |
| 0 | Basic |
| 1 | BF Report Poll (BFRP) |
| 2 | MU-BAR |
| 3 | MU-RTS |
| 4 | Buffer Status Report |
| | Poll (BSRP) |
| 5 | GCR MU-BAR |
| 6 | Bandwidth Query |
| | Report Poll (BQRP) |
| 7 | NDP Feedback Report |
| | Poll (NFRP) |
| 8-15 | Reserved |

In embodiments and examples provided herein, an RU may refer to one or more subcarriers used in DL and UL transmissions. Also, a tone may refer to a transmission carried over one subcarrier used in DL or UL transmission. A DRU is a resource unit whose subcarriers are spread over a certain bandwidth which is larger than the bandwidth effectively occupied by this resource unit. The effective bandwidth of an RU equals N×Δfₛ where N is the number of tones of the RU and Δfₛ is the subcarrier spacing. In WLAN, range extension can be achieved by distributing the tones of an RU over a wider bandwidth which allows for higher transmit power for each individual tone. A portion of bandwidth, such as one or more subcarriers, may be effectively occupied if that portion carries a tone. In examples, one or more subcarriers of a DRU may be separated from each other by a portion of empty bandwidth, or bandwidth not used for a tone or transmission. Further, a DRU may also be referred to as a tone distributed (TD) RU (TD-RU) or a distributed RU, and still be consistent with the embodiments and example provided herein.

Also, a distribution bandwidth may refer to a bandwidth in which the tones of a set of one or more DRUs are spread on. An RRU may refer to a resource unit whose subcarriers are contiguous as defined by 11ax and 11be amendments. In addition, a punctured channel may refer to a channel that has one or more of its subchannels punctured. Further, a punctured subchannel may refer to a subchannel that is left unused by any PPDU that is transmitted within the operating channel of the AP to a member of the BSS. Moreover, a puncturing pattern may refer to a specific set of subchannels that are punctured in the operating channel.

The resource allocation of DRUs in uplink and downlink transmission for both single user and multi-user PPDUs in punctured or non-punctured channels are included in embodiments and examples provided herein. A resource allocation mechanism to enable allocation of DRUs in various scenarios of PPDU transmission is described herein. Various scenarios of PPDU transmission may include one or more of UL transmission, DL transmission, single-user (SU) PPDUs, multi-user (MU) PPDUs, punctured channels, non-punctured channels, and the like.

Further, enabling DRUs in a punctured channel is challenging since there may be different ways to choose the distribution bandwidth. For instance, in a punctured 80 MHz channel, there are 7 different patterns of puncturing. Accordingly, the distribution bandwidth may be chosen in different ways. How the distribution bandwidth will be chosen and how the DRU will be allocated to different STAs given the choice of the distribution bandwidth are included in embodiments and examples provided herein.

Embodiments and examples provided herein include the resource allocation of DRUs. Specifically, a resource allocation of DRUs may be provided in the trigger frame of PPDUs, such as TB PPDUs. In an example, the distribution bandwidth of the DRU allocated to a user may be indicated in the User Info field, such as one or more of the User Info fields shown in Table 1 or FIG. 3. In one example, a field named Distribution Bandwidth in the User Info field may be used to encode the different variants of the distribution bandwidth as listed in Table 3, below.

TABLE 3
Encoding of the Distribution Bandwidth field

| Distribution Bandwidth | Allocated Distribution | |
|---|---|---|
| field Value | Bandwidth | |
| 0 | RRU | (Regular RU) |
| 1 | 20 | MHz |
| 2 | 40 | MHz |
| 3 | 80 | MHz |
| 4 | 160 | MHz |
| 5 | 320 | MHz |

In another example, the distribution bandwidth of the DRUs allocated to users may be indicated in the Common Info field, such as in Table 1, FIG. 2A, or FIG. 2B. Additionally or alternatively, the distribution bandwidth of the DRUs allocated to users may be indicated in the Special User Info field, such as in FIG. 2C.

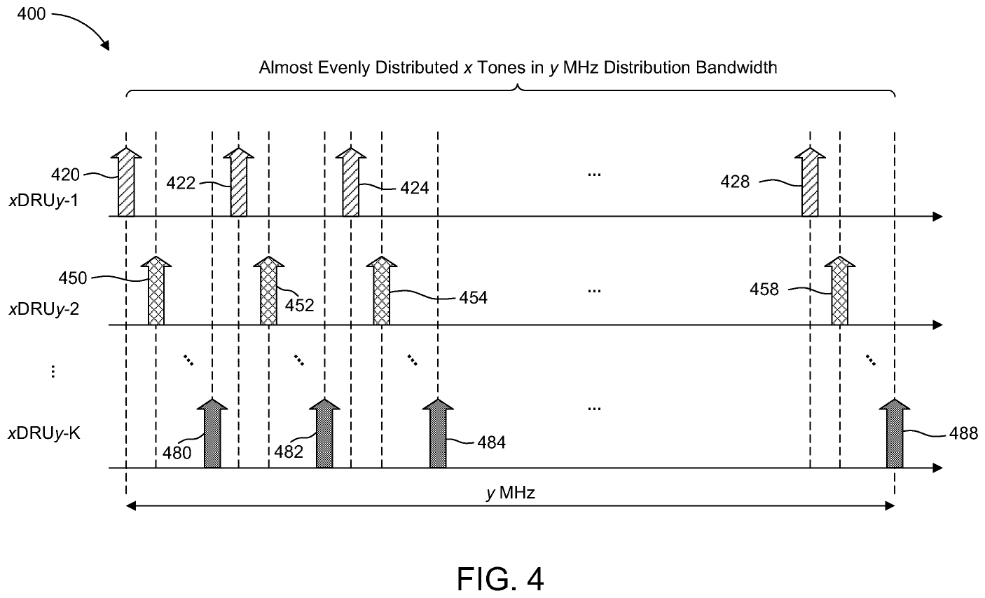

FIG. 4 is a transmission diagram illustrating a general example of a distributed-tone resource unit (DRU) over a distribution bandwidth. As shown in an example in transmission diagram 400, a general x-tones DRU may be distributed over a y MHz distribution bandwidth, and may be denoted as xDRUy. In an example, a 26DRU20 is a 26-tone resource unit (effective bandwidth is ˜2 MHZ) with a DRU allocation spread over a distribution bandwidth of 20 MHZ. In another example, a 106DRU80 is a 106-tone resource unit (effective bandwidth is ˜8 MHZ) with a DRU allocation spread over a distribution bandwidth of 80 MHz. A 20 MHz channel may include up to nine 26DRU20 DRU allocations, four 52DRU20 DRU allocations, or two 106DRU20 DRU allocations. For proper transmission, a channel bandwidth should accommodate the effective bandwidth of the DRUs as well as bandwidth needed for guard, null and DC subcarriers.

In an example shown in FIG. 4 for resource allocations for an xDRUy, a first DRU allocation for a first DRU type, such as xDRUy−1 may include a tone plan with tone distributed across subcarriers over a y MHz distribution bandwidth. For example, the tone plan for xDRUy−1 may include the transmission of tones 420, 422, 424, 428 over a first set of distributed subcarriers. The second DRU allocation for a second DRU type may include a tone plan for xDRUy−2. The tone plan for DRU allocation xDRUy−2 may transmit over a second set of distributed subcarriers adjacent to, but not overlapping with, the first set of distributed subcarriers. For example, the tone plan for DRU allocation xDRUy−2 may include the transmission of tones 450, 452, 454, 458 over the second set of distributed subcarriers. In order to ensure that the tones in tone plan for DRU allocation xDRUy−1 do not overlap with the tones in the tone plan for DRU allocation xDRUy−2, the spacing between the tones of the tone plan for DRU allocation xDRUy−1 will match the spacing between the tones of the tone plan for DRU allocation xDRUy−2, as shown in FIG. 4.

Further tone plans for the remaining DRU allocations for the remaining DRU types may include transmissions of tones over distributed subcarriers that do not overlap with the distributed subcarriers of the other tone plans. Similarly, the spacing between the tones within each of the tone plans will match for all DRU allocations for the DRU types of xDRUy, in order to ensure that the tones of one tone plan do not overlap with the tones of another. Moreover, the final DRU type, xDRUy-K will have a DRU allocation for its DRU type, including a tone plan with transmission of tones 480, 482, 484, 488 over another set of distributed subcarriers. In this way, the DRU allocations for the DRU types of xDRUy include almost evenly distributed x tones in the y MHz distribution bandwidth.

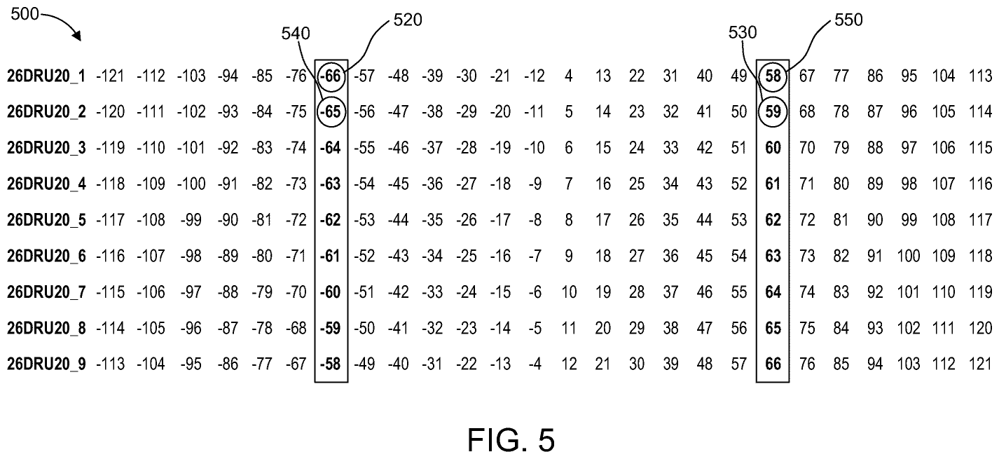

FIG. 5 is a tone plan diagram illustrating an example of a tone plan for 26DRU20. As shown in tone plan diagram 500, 26DRU20 may include one or more of the nine listed DRU allocations, 26DRU20_1 through 26DRU20_9. Further, the highlighted tones in the rectangular boxes are the pilot tones for each DRU allocation. For example, the pilot tones of DRU allocation 26DRU20_1 are at tone index {−66, 58} 520, 550 and the pilot tones of DRU allocation 26DRU20_2 are tone index {−65, 59} 540, 530.

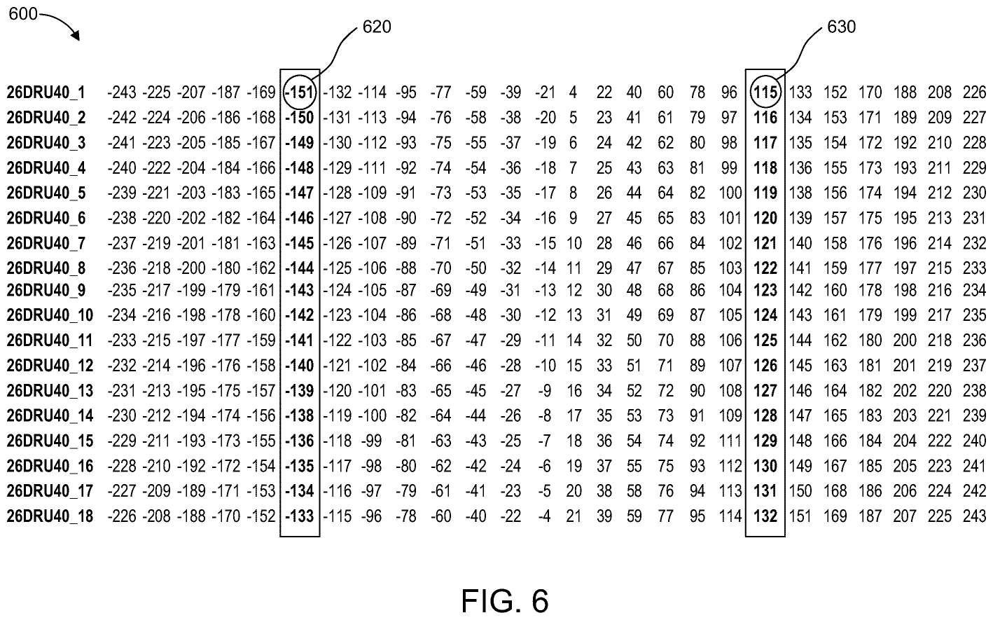

FIG. 6 is a tone plan diagram illustrating an example of a tone plan for 26DRU40. As shown in tone plan diagram 600, 26DRU40 may include one or more of the eighteen listed DRU allocations, 26DRU40_1 through 26DRU40_18. Further, the highlighted tones in the rectangular boxes are the pilot tones for each DRU allocation. For example, the pilot tones of DRU allocation 26DRU40_1 are tone index {−151, 115} 620, 630.

In examples provided herein, one may assign a DRU index to a DRU allocation. An AP may then communicate this DRU index to a STA in order to instruct the STA with the DRU allocation. The STA may then transmit data, such as data tones, to the AP using the DRU allocation. In an example, the AP may be pre-configured with the DRU index assignments. In another example, the AP may generate the DRU index assignments. Further, the STA may be pre-configured with the DRU index assignments, in an example. For example, the STA may receive the DRU index assignments from the AP. In another example, the STA may be provided with the index assignments before communicating with the AP. Moreover, the STA may generate the DRU index assignments, in an example. Further, the STA may also provide the DRU index assignments to the AP.

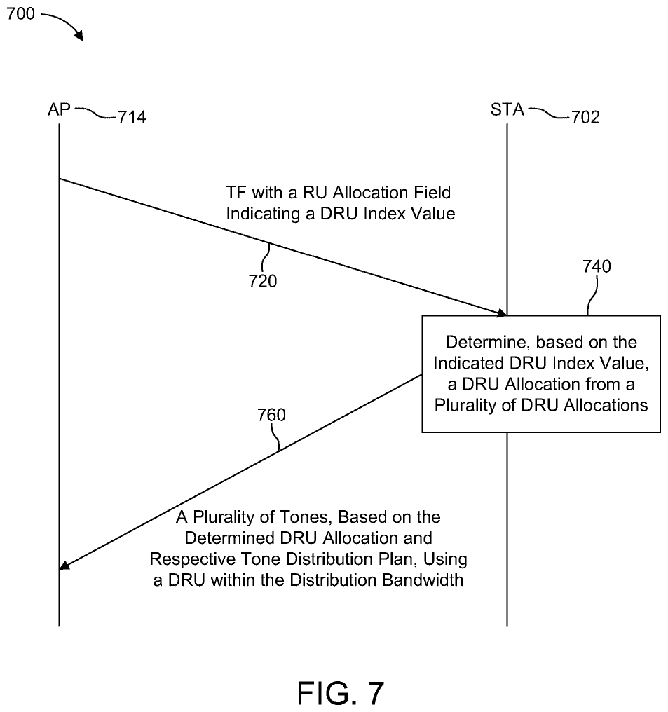

FIG. 7 is a signaling diagram illustrating an example of a resource allocation for one or more DRUs. As shown in signaling diagram 700, an AP 714 transmits a trigger frame with an RU allocation field 720 to a STA 702. In an example, the AP 714 may be the same as, or similar to, base station 114a in FIG. 1A. Further, the STA 702 may be the same as, or similar to, WTRU 102a in FIG. 1A, WTRU 102 in FIG. 1B, or both, in examples. The RU allocation field includes indication information indicating a DRU index value 720. Accordingly, the STA 702 receives a trigger frame with an RU allocation field indicating the DRU index value, and the STA 702 determines, based on the indicated DRU index value, a DRU allocation from a plurality of DRU allocations 740. Each of the plurality of DRU allocations includes a respective tone distribution plan. Further, tones of the determine DRU allocation and the respective tone distribution plan are interleaved with tones of one or more other tone distribution plans, of the plurality of tone distribution plans, across a distribution bandwidth.

The STA 702 then transmits, to the AP 714, a plurality of tones using a DRU within the distribution bandwidth, based on the determine DRU allocation and the respective tone distribution plan. Accordingly, the AP receives the plurality of tones using a DRU within the distribution bandwidth. The plurality of tones may carry data and be data tones, in an example. As shown according to an example in signaling diagram 700, the STA may receive a tone distribution plan.

In a further example, the trigger frame may include information indicating the distribution bandwidth. Moreover, the determination by the STA of the DRU allocation may be further based on the indicated distribution bandwidth.

Further, the plurality of tones may be transmitted over a plurality of RUs, in an example. Also, the determined DRU allocation may further include the distribution bandwidth. In another example, the determined DRU allocation and respective subcarrier tone distribution plan may further include a distribution of subcarrier tones in regions outside of punctured subchannels within a channel. In a further example, the STA may determine the DRU size based on the DRU index value. Additionally or alternatively, the STA may determine the DRU size based on the RU allocation. Additionally or alternatively, the STA may determine the DRU size based on the distribution bandwidth. Further, the STA may determine the DRU allocation further based on the DRU size as well as the DRU index value. Additionally or alternatively, the STA may determine the distribution bandwidth based on the DRU size.

Additionally or alternatively, the RU allocation field may be received in a User Info field of the trigger frame. Additionally or alternatively, the AP may transmit, and the STA may receive, the RU allocation field in a UHR-SIG field of a PPDU. Additionally or alternatively, the RU allocation field may be received in a control information sub-field in a triggered response scheduling (TRS) control field of a PPDU.

In an example, one may define up to 36 DRU allocations for 26-tone DRUs for each 80 MHz segment on the distribution bandwidths 20 MHz/40 MHz/80 MHz as listed in Table 4, below.

TABLE 4
List of RU Indices for 26-tone DRU on Different
Distribution Bandwidths in an 80 MHz Segment

| DRU Type | | DRU Type | | DRU Type | |
|---|---|---|---|---|---|
| (Distribution | | (Distribution | | (Distribution | |
| Bandwidth = | DRU | Bandwidth = | DRU | Bandwidth = | DRU |
| 20 MHz) | Index | 40 MHz) | Index | 80 MHz) | Index |
| 26DRU20_1 | DRU1 | 26DRU40_1 | DRU37 | 26DRU80_1 | DRU73 |
| 26DRU20_2 | DRU2 | 26DRU40_2 | DRU38 | 26DRU80_2 | DRU74 |
| . . . | . . . | . . . | . . . | . . . | . . . |
| 26DRU20_36 | DRU36 | 26DRU40_36 | DRU72 | 26DRU80_36 | DRU108 |

As shown above, each DRU type with a DRU allocation within the 80 MHz segment is assigned a different DRU Index. For example, for distribution bandwidth 20 MHz within the 80 MHz segment, a DRU type with DRU allocation 26DRU20_1 is assigned DRU index DRU1, a DRU type with DRU allocation 26DRU20_2 is assigned DRU index DRU2, a DRU type with DRU allocation 26DRU20_3 is assigned DRU index DRU3, and so forth until a DRU type with DRU allocation 26DRU20_36 is assigned DRU index DRU36. Further, for distribution bandwidth 40 MHz within the 80 MHz segment, a DRU type with DRU allocation 26DRU40_1 is assigned DRU index DRU37, a DRU type with DRU allocation 26DRU40_2 is assigned DRU index DRU38, a DRU type with DRU allocation 26DRU20_3 is assigned DRU index DRU39, and so forth until a DRU type with DRU allocation 26DRU40_36 is assigned DRU index DRU72. Moreover, for distribution bandwidth 80 MHz within the 80 MHz segment, a DRU type with DRU allocation 26DRU80_1 is assigned DRU index DRU73, a DRU type with DRU allocation 26DRU80_2 is assigned DRU index DRU74, a DRU type with DRU allocation 26DRU80_3 is assigned DRU index DRU75, and so forth until a DRU type with DRU allocation 26DRU80_36 is assigned DRU index DRU108. In this way, up to 108 DRU indexes may be assigned in the 80 MHz segment.

In an example, the AP may communicate one of the DRU indexes from Table 4 to a STA in order to instruct the STA with the DRU allocation. For example, the AP may communicate DRU index DRU4 to the STA so that the STA uses DRU allocation 26DRU20_4. The STA may then transmit data, such as data tones, to the AP using the DRU allocation 26DRU20_4 in a 20 MHz distribution bandwidth in an 80 MHz segment. In an example, DRU allocation 26DRU20_4 may use the tone plan shown in FIG. 5. In another example, DRU allocation 26DRU20_4 may use another tone plan. Further, in additional examples, different bandwidth segments may be used by an AP and a STA, and DRU indexes may be assigned in similar manner as explained above, accordingly. Further such examples are provided in the following.

In another example, one may define up to 16 DRU allocations for 52-tone DRUs for each 80 MHz segment on the distribution bandwidths 20 MHz/40 MHz/80 MHz as listed in Table 5, below.

TABLE 5
List of RU Indices for 52-tone DRU on Different
Distribution Bandwidths in an 80 MHz Segment

| DRU Type | | DRU Type | | DRU Type | |
|---|---|---|---|---|---|
| (Distribution | | (Distribution | | (Distribution | |
| Bandwidth = | DRU | Bandwidth = | DRU | Bandwidth = | DRU |
| 20 MHz) | Index | 40 MHz) | Index | 80 MHz) | Index |
| 52DRU20_1 | DRU1 | 52DRU40_1 | DRU17 | 52DRU80_1 | DRU33 |
| 52DRU20_2 | DRU2 | 52DRU40_2 | DRU18 | 52DRU80_2 | DRU34 |
| . . . | . . . | . . . | . . . | . . . | . . . |
| 52DRU20_16 | DRU16 | 52DRU40_16 | DRU32 | 52DRU80_16 | DRU48 |

In a further example, one may define up to 8 DRU allocations for 106-tone DRUs for each 80 MHz segment on the distribution bandwidths 20 MHz/40 MHz/80 MHz as listed in Table 6, below.

TABLE 6
List of RU Indices for 106-tone DRU on Different
Distribution Bandwidths in an 80 MHz Segment

| DRU Type | | DRU Type | | DRU Type | |
|---|---|---|---|---|---|
| (Distribution | | (Distribution | | (Distribution | |
| Bandwidth = | DRU | Bandwidth = | DRU | Bandwidth = | DRU |
| 20 MHz) | Index | 40 MHz) | Index | 80 MHz) | Index |
| 106DRU20_1 | DRU1 | 106DRU40_1 | DRU9 | 106DRU80_1 | DRU17 |
| 106DRU20_2 | DRU2 | 106DRU40_2 | DRU10 | 106DRU80_2 | DRU18 |
| . . . | . . . | . . . | . . . | . . . | . . . |
| 106DRU20_8 | DRU8 | 106DRU40_8 | DRU16 | 106DRU80_8 | DRU24 |

In an additional example, one may define up to 4 DRU allocations for 242-tone DRUs for each 80 MHz segment on the distribution bandwidths 80 MHz as listed in Table 7, below.

TABLE 7
List of RU Indices for 242-tone DRU on Distribution
Bandwidth 80 MHz in an 80 MHz Segment

| DRU Type | |
|---|---|
| (Distribution | |
| Bandwidth = | |
| 80 MHz) | DRU Index |
| 242DRU80_1 | DRU1 |
| 242DRU80_2 | DRU2 |
| 242DRU80_3 | DRU3 |
| 242DRU80_4 | DRU4 |

In yet another example, one may define up to 2 DRU allocations for 484-tone DRU allocations for each 80 MHZ segment on the distribution bandwidths 80 MHz as listed in Table 8, below.

TABLE 8
List of RU Indices for 484-tone DRU on Distribution
Bandwidth 80 MHz in an 80 MHz Segment

| DRU Type | |
|---|---|
| (Distribution | |
| Bandwidth = | |
| 80 MHz) | DRU Index |
| 484DRU80_1 | DRU1 |
| 484DRU80_2 | DRU2 |

In an example, the Distribution Bandwidth field along with the RU Allocation field in the User Info field in the Trigger frame, such as shown in Table 1, may be used to determine the resource allocation for each user identified in the User Info list of the Trigger frame. In an example, the User Info list is the list of User Info fields for all users identified in the trigger frame. The RU Allocation field in the User Infor field in the Trigger frame may be encoded to signal the DRU resource allocation as listed in Table 9, below.

TABLE 9
An example of the Encoding of the RU Allocation subfield
in the User Info field of the Trigger frame

| B7-B1 of the RU | Distribution | | |
|---|---|---|---|
| Allocation field | Bandwidth | DRU Size | DRU Index |
| 0-17 | 20 MHz | 26DRU20 | DRU1 to DRU18 |
| | 40 MHz | 26DRU40 | DRU37 to DRU54 |
| | 80 MHz | 26DRU80 | DRU73 to DRU90 |
| 18 | | | Reserved |
| 19-36 | 20 MHz | 26DRU20 | DRU19 to DRU36 |
| | 40 MHz | 26DRU40 | DRU55 to DRU72 |
| | 80 MHz | 26DRU80 | DRU91 to DRU 108 |
| 37-52 | 20 MHz | 52DRU20 | DRU1 to DRU16 |
| | 40 MHz | 52DRU40 | DRU17 to DRU32 |
| | 80 MHz | 52DRU80 | DRU33 to DRU48 |
| 53-60 | 20 MHz | 106DRU20 | DRU1 to DRU8 |
| | 40 MHz | 106DRU40 | DRU9 to DRU16 |
| | 80 MHz | 106DRU80 | DRU17 to DRU24 |
| 61-64 | 80 MHz | 242DRU80 | DRU1 to DRU4 |
| 65, 66 | 80 MHz | 484DRU80 | DRU1 and DRU2 |

In an example shown using Table 9, an AP may transmit the RU allocation field and the distribution bandwidth field to a STA. For example, these fields may be transmitted in a trigger frame. The STA may then determine, based on the received allocation field and the received distribution bandwidth field, a DRU size and a DRU index. Further, the STA may then use the DRU size and the DRU index to determine the DRU allocation to use for transmission. Accordingly, the STA may transmit data tones to the AP using the DRU allocation.

For example, an AP may transmit a trigger frame with a 0 in the RU allocation field and indication information indicating 20 MHz in the distribution bandwidth field to a STA. The STA determines to use a 20 MHz distribution bandwidth based on the indication information. Further, the STA determines to use DRU index DRU1 based on the received 0 in the RU allocation field as the first DRU index to use for a 20 MHz distribution bandwidth. The STA will also determine to use a DRU size of 26DRU20 based on the received 0 in the RU allocation field and the 20 MHz distribution bandwidth. In an example, if the STA is communicating in an 80 MHz segment, the STA may then determine to use DRU allocation 26DRU20_1 based on index DRU1 and DRU size 26DRU20, per Table 4. Table 4 may be used because the STA may determine that a 26-tone DRU may be used based on DRU size 26DRU20.

For example, the STA may then transmit data, such as data tones, to the AP using the DRU allocation 26DRU20_1 in a 20 MHz distribution bandwidth in an 80 MHz segment. In an example, DRU allocation 26DRU20_1 may use the tone plan shown in FIG. 5, and use pilot tones {−66, 58} 520, 550. Further, in additional examples, different DRU allocations and bandwidth segments may be used by an AP and a STA, and DRU indexes may be assigned in similar manner as explained above, accordingly.

In another example, an AP may transmit a trigger frame with a 0 in the RU allocation field and indication information indicating 40 MHz in the distribution bandwidth field to a STA. The STA determines to use a 40 MHz distribution bandwidth based on the indication information. Further, the STA determines to use DRU index DRU37 based on the received 0 in the RU allocation field as the first DRU index to use for a 40 MHz distribution bandwidth. The STA will also determine to use a DRU size of 26DRU40 based on the received 0 in the RU allocation field and the 40 MHz distribution bandwidth. In an example, if the STA is communicating in an 80 MHz segment, the STA may then determine to use DRU allocation 26DRU40_1 based on index DRU37 and DRU size 26DRU40, per Table 4.

Similar examples include the AP transmitting a trigger frame with other values in the RU allocation field and the distribution bandwidth field to the STA, resulting in different DRU indexes and DRU allocations, as one of ordinary skill in the art will readily understand.

For clarity, Table 10 is provided below, which may be considered a sub-table of Table 9 showing the individual correspondence of the RU allocation field and the DRU Indexes for a 20 MHz distribution bandwidth and a 26DRU20 DRU size.

TABLE 10
Encoding of the RU Allocation subfield for values
0 through 17 and a 20 MHz Distribution Bandwidth

| B7-B1 of the RU | Distribution | | |
|---|---|---|---|
| Allocation field | Bandwidth | DRU Size | DRU Index |
| 0 | 20 MHz | 26DRU20 | DRU1 |
| 1 | 20 MHz | 26DRU20 | DRU2 |
| 2 | 20 MHz | 26DRU20 | DRU3 |
| 3 | 20 MHz | 26DRU20 | DRU4 |
| 4 | 20 MHz | 26DRU20 | DRU5 |
| 5 | 20 MHz | 26DRU20 | DRU6 |
| 6 | 20 MHz | 26DRU20 | DRU7 |
| 7 | 20 MHz | 26DRU20 | DRU8 |
| 8 | 20 MHz | 26DRU20 | DRU9 |
| 9 | 20 MHz | 26DRU20 | DRU10 |
| 10 | 20 MHz | 26DRU20 | DRU11 |
| 11 | 20 MHz | 26DRU20 | DRU12 |
| 12 | 20 MHz | 26DRU20 | DRU13 |
| 13 | 20 MHz | 26DRU20 | DRU14 |
| 14 | 20 MHz | 26DRU20 | DRU15 |
| 15 | 20 MHz | 26DRU20 | DRU16 |
| 16 | 20 MHz | 26DRU20 | DRU17 |
| 17 | 20 MHz | 26DRU20 | DRU18 |

For further clarity, Table 11 is provided below, which may be considered another sub-table of Table 9 showing the individual correspondence of the RU allocation field and the DRU Indexes for a 40 MHz distribution bandwidth and a 26DRU40 DRU size.

TABLE 11
Encoding of the RU Allocation subfield for values
0 through 17 and a 40 MHz Distribution Bandwidth

| B7-B1 of the RU | Distribution | | |
|---|---|---|---|
| Allocation field | Bandwidth | DRU Size | DRU Index |
| 0 | 40 MHz | 26DRU40 | DRU37 |
| 1 | 40 MHz | 26DRU40 | DRU38 |
| 2 | 40 MHz | 26DRU40 | DRU39 |
| 3 | 40 MHz | 26DRU40 | DRU40 |
| 4 | 40 MHz | 26DRU40 | DRU41 |
| 5 | 40 MHz | 26DRU40 | DRU42 |
| 6 | 40 MHz | 26DRU40 | DRU43 |
| 7 | 40 MHz | 26DRU40 | DRU44 |
| 8 | 40 MHz | 26DRU40 | DRU45 |
| 9 | 40 MHz | 26DRU40 | DRU46 |
| 10 | 40 MHz | 26DRU40 | DRU47 |
| 11 | 40 MHz | 26DRU40 | DRU48 |
| 12 | 40 MHz | 26DRU40 | DRU49 |
| 13 | 40 MHz | 26DRU40 | DRU50 |
| 14 | 40 MHz | 26DRU40 | DRU51 |
| 15 | 40 MHz | 26DRU40 | DRU52 |
| 16 | 40 MHz | 26DRU40 | DRU53 |
| 17 | 40 MHz | 26DRU40 | DRU54 |

In another example, the RU Allocation field in the User Infor field in the Trigger frame may be increased to 9 bits and encoded to signal the DRU resource allocation as listed in Table 12, below.

TABLE 12
Another example of the Encoding of the RU Allocation
subfield in the User Info field of the Trigger frame

| B8-B1 of the RU | | |
|---|---|---|
| Allocation field | DRU Size | DRU Index |
| 0-17 | 26DRU20 | DRU1 to DRU18 |
| 18 | | Reserved |
| 19-36 | 26DRU20 | DRU19 to DRU36 |
| 37-52 | 52DRU20 | DRU1 to DRU16 |
| 53-60 | 106DRU20 | DRU1 to DRU8 |
| 61-64 | 242DRU80 | DRU1 to DRU4 |
| 65, 66 | 484DRU80 | DRU1 and DRU2 |
| 67-102 | 26DRU40 | DRU37 to DRU72 |
| 103-118 | 52DRU40 | DRU17 to DRU32 |
| 119-126 | 106DRU40 | DRU9 to DRU16 |
| 127-162 | 26DRU80 | DRU73 to DRU108 |
| 163-178 | 52DRU80 | DRU33 to DRU48 |
| 179-186 | 106DRU80 | DRU17 to DRU24 |

In Table 12, the distribution bandwidth field is not separately communicated to the STA, in contrast to Table 9. In an example, the STA may determine the distribution bandwidth based on the DRU size of the DRU allocation. For example, the AP will transmit the RU allocation field to the STA, and the STA may then determine both the DRU size and DRU index based on the RU allocation field. Further, the STA may then use the DRU size and the DRU index to determine the DRU allocation to use for transmission. Accordingly, the STA may transmit data tones to the AP using the DRU allocation.

In an example shown in Table 12, an AP may transmit a trigger frame with a 37 in the RU allocation field to a STA. The STA determines to use DRU size 52DRU20 based on the received 37 in the RU allocation field. Also, the STA determines to use DRU index DRU1 based on the received 37 in the RU allocation field as the first DRU index to use for a DRU size 52DRU20. Accordingly, the STA may determine that the distribution bandwidth size is 20 MHz based on the DRU size of 52DRU20. In an example, if the STA is communicating in an 80 MHz segment, the STA may then determine to use DRU allocation 52DRU20_1 based on index DRU1 and DRU size 52DRU20, per Table 5. Table 5 may be used because the STA may determine that a 52-tone DRU may be used based on DRU size 52DRU20. The STA may then transmit data tones using the DRU allocation 52DRU20_1.

In an example, the Resource Allocation field in the UHR-SIG field may be designed for downlink MU transmission using DRUs as listed in Table 13 or Table 14, below, for a distribution bandwidth of 20 MHz. Further, the Resource Allocation field in the UHR-SIG field may be designed for downlink MU transmission using DRUs as listed in Table 15 and Table 16 for a first design, or Table 17 and Table 18 for a second design, below, for a distribution bandwidth of 40 MHz.

In another example, the Resource Allocation field in the UHR-SIG field may be used in the uplink SU transmission using DRUs to indicate the DRU used for transmission as listed in Table 13 or Table 14, below, for a distribution bandwidth of 20 MHz. Further, the Resource Allocation field in the UHR-SIG field may in the uplink SU transmission using DRUs to indicate the DRU used for transmission as listed in Table 15 and Table 16 for a first design, or Table 17 and Table 18 for a second design, below, for a distribution bandwidth of 40 MHZ. In uplink SU transmission, the STA may use the first DRU for any RU allocation by default for the transmission. In one example, if the RU Allocation field is 6, then the STA may use the first 106DRU20 for the transmission.

TABLE 13
A Design of the RU Allocation field in the UHR-SIG field for DRUs for a Distribution Bandwidth of 20 MHz

| RU | | | | | | | | | |
|---|---|---|---|---|---|---|---|---|---|
| Allocation | | | | | | | | | |
| field | 1 | 2 | 3 | 4 | 5 | 6 | 7 | 8 | 9 |
| 0 | 26DRU20 | 26DRU20 | 26DRU20 | 26DRU20 | 26DRU20 | 26DRU20 | 26DRU20 | 26DRU20 | 26DRU20 |

| | | | | | | | | |
|---|---|---|---|---|---|---|---|---|
| 1 | 52DRU20 | 26DRU20 | 26DRU20 | 26DRU20 | 26DRU20 | 26DRU20 | 26DRU20 | 26DRU20 |

| | | | | | | | |
|---|---|---|---|---|---|---|---|
| 2 | 52DRU20 | 52DRU20 | 26DRU20 | 26DRU20 | 26DRU20 | 26DRU20 | 26DRU20 |

| | | | | | | |
|---|---|---|---|---|---|---|
| 3 | 52DRU20 | 52DRU20 | 26DRU20 | 52DRU20 | 26DRU20 | 26DRU20 |

| | | | | | |
|---|---|---|---|---|---|
| 4 | 52DRU20 | 52DRU20 | 26DRU20 | 52DRU20 | 52DRU20 |

| | | | | |
|---|---|---|---|---|
| 5 | 106DRU20 | 26DRU20 | 52DRU20 | 52DRU20 |

| | | | |
|---|---|---|---|
| 6 | 106DRU20 | 26DRU20 | 106DRU20 |

TABLE 14
Another Design of the RU Allocation field in the UHR-SIG
field for DRUs for a Distribution Bandwidth of 20 MH

| RU | | | | | | | | | |
|---|---|---|---|---|---|---|---|---|---|
| Allocation | | | | | | | | | |
| field | 1 | 6 | 3 | 8 | 5 | 2 | 7 | 4 | 9 |
| 0 | 26DRU20 | 26DRU20 | 26DRU20 | 26DRU20 | 26DRU20 | 26DRU20 | 26DRU20 | 26DRU20 | 26DRU20 |

| | | | | | | | | |
|---|---|---|---|---|---|---|---|---|
| 1 | 52DRU20 | 26DRU20 | 26DRU20 | 26DRU20 | 26DRU20 | 26DRU20 | 26DRU20 | 26DRU20 |

| | | | | | | | |
|---|---|---|---|---|---|---|---|
| 2 | 52DRU20 | 52DRU20 | 26DRU20 | 26DRU20 | 26DRU20 | 26DRU20 | 26DRU20 |

| | | | | | | |
|---|---|---|---|---|---|---|
| 3 | 52DRU20 | 52DRU20 | 26DRU20 | 52DRU20 | 26DRU20 | 26DRU20 |

| | | | | | |
|---|---|---|---|---|---|
| 4 | 52DRU20 | 52DRU20 | 26DRU20 | 52DRU20 | 52DRU20 |

| | | | | |
|---|---|---|---|---|
| 5 | 106DRU20 | 26DRU20 | 52DRU20 | 52DRU20 |

| | | | |
|---|---|---|---|
| 6 | 106DRU20 | 26DRU20 | 106DRU20 |

TABLE 15
First Part of a Design of the RU Allocation field in the UHR-
SIG field for DRUs for a Distribution Bandwidth of 40 MHz

| RU | | | | | | | | | |
|---|---|---|---|---|---|---|---|---|---|
| Allocation | | | | | | | | | |
| field | 1 | 2 | 3 | 4 | 5 | 6 | 7 | 8 | 9 |
| 0 | 26DRU40 | 26DRU40 | 26DRU40 | 26DRU40 | 26DRU40 | 26DRU40 | 26DRU40 | 26DRU40 | 26DRU40 |

| | | | | | | | | |
|---|---|---|---|---|---|---|---|---|
| 1 | 52DRU40 | 26DRU40 | 26DRU40 | 26DRU40 | 26DRU40 | 26DRU40 | 26DRU40 | 26DRU40 |

| | | | | | | | |
|---|---|---|---|---|---|---|---|
| 2 | 52DRU40 | 52DRU40 | 26DRU40 | 26DRU40 | 26DRU40 | 26DRU40 | 26DRU40 |

| | | | | | | |
|---|---|---|---|---|---|---|
| 3 | 52DRU40 | 52DRU40 | 26DRU40 | 52DRU40 | 26DRU40 | 26DRU40 |

| | | | | | |
|---|---|---|---|---|---|
| 4 | 52DRU40 | 52DRU40 | 26DRU40 | 52DRU40 | 52DRU40 |
| 5 | 52DRU40 | 52DRU40 | 26DRU40 | 52DRU40 | 52DRU40 |
| 6 | 52DRU40 | 52DRU40 | 26DRU40 | 52DRU40 | 52DRU40 |
| 7 | 52DRU40 | 52DRU40 | 26DRU40 | 52DRU40 | 52DRU40 |
| 8 | 52DRU40 | 52DRU40 | 26DRU40 | 52DRU40 | 52DRU40 |

| | | | | |
|---|---|---|---|---|
| 9 | 106DRU40 | 26DRU40 | 52DRU40 | 52DRU40 |

| | | | |
|---|---|---|---|
| 10 | 106DRU40 | 26DRU40 | 106DRU40 |
| 11 | 106DRU40 | 26DRU40 | 106DRU40 |
| 12 | 106DRU40 | 26DRU40 | 106DRU40 |

TABLE 16
Second Part of a Design of the RU Allocation field in the UHR-
SIG field for DRUs for a Distribution Bandwidth of 40 MHz

| RU | | | | | | | | | |
|---|---|---|---|---|---|---|---|---|---|
| Allocation | | | | | | | | | |
| field | 10 | 11 | 12 | 13 | 14 | 15 | 16 | 17 | 18 |
| 0 | 26DRU40 | 26DRU40 | 26DRU40 | 26DRU40 | 26DRU40 | 26DRU40 | 26DRU40 | 26DRU40 | 26DRU40 |
| 1 | 26DRU40 | 26DRU40 | 26DRU40 | 26DRU40 | 26DRU40 | 26DRU40 | 26DRU40 | 26DRU40 | 26DRU40 |
| 2 | 26DRU40 | 26DRU40 | 26DRU40 | 26DRU40 | 26DRU40 | 26DRU40 | 26DRU40 | 26DRU40 | 26DRU40 |
| 3 | 26DRU40 | 26DRU40 | 26DRU40 | 26DRU40 | 26DRU40 | 26DRU40 | 26DRU40 | 26DRU40 | 26DRU40 |
| 4 | 26DRU40 | 26DRU40 | 26DRU40 | 26DRU40 | 26DRU40 | 26DRU40 | 26DRU40 | 26DRU40 | 26DRU40 |

| | | | | | | | | |
|---|---|---|---|---|---|---|---|---|
| 5 | 52DRU40 | 26DRU40 | 26DRU40 | 26DRU40 | 26DRU40 | 26DRU40 | 26DRU40 | 26DRU40 |

| | | | | | | | |
|---|---|---|---|---|---|---|---|
| 6 | 52DRU40 | 52DRU40 | 26DRU40 | 26DRU40 | 26DRU40 | 26DRU40 | 26DRU40 |

| | | | | | | |
|---|---|---|---|---|---|---|
| 7 | 52DRU40 | 52DRU40 | 26DRU40 | 52DRU40 | 26DRU40 | 26DRU40 |

| | | | | | |
|---|---|---|---|---|---|
| 8 | 52DRU40 | 52DRU40 | 26DRU40 | 52DRU40 | 52DRU40 |
| 9 | 52DRU40 | 52DRU40 | 26DRU40 | 52DRU40 | 52DRU40 |
| 10 | 52DRU40 | 52DRU40 | 26DRU40 | 52DRU40 | 52DRU40 |

| | | | | |
|---|---|---|---|---|
| 11 | 106DRU40 | 26DRU40 | 52DRU40 | 52DRU40 |

| | | | |
|---|---|---|---|
| 12 | 106DRU40 | 26DRU40 | 106DRU40 |

TABLE 17
First Part of Another Design of the RU Allocation field in the
UHR-SIG field for DRUs for a Distribution Bandwidth of 40 MHz

| RU | | | | | | | | | |
|---|---|---|---|---|---|---|---|---|---|
| Allocation | | | | | | | | | |
| field | 1 | 6 | 3 | 8 | 5 | 2 | 7 | 4 | 9 |
| 0 | 26DRU40 | 26DRU40 | 26DRU40 | 26DRU40 | 26DRU40 | 26DRU40 | 26DRU40 | 26DRU40 | 26DRU40 |

| | | | | | | | | |
|---|---|---|---|---|---|---|---|---|
| 1 | 52DRU40 | 26DRU40 | 26DRU40 | 26DRU40 | 26DRU40 | 26DRU40 | 26DRU40 | 26DRU40 |

| | | | | | | | |
|---|---|---|---|---|---|---|---|
| 2 | 52DRU40 | 52DRU40 | 26DRU40 | 26DRU40 | 26DRU40 | 26DRU40 | 26DRU40 |

| | | | | | | |
|---|---|---|---|---|---|---|
| 3 | 52DRU40 | 52DRU40 | 26DRU40 | 52DRU40 | 26DRU40 | 26DRU40 |

| | | | | | |
|---|---|---|---|---|---|
| 4 | 52DRU40 | 52DRU40 | 26DRU40 | 52DRU40 | 52DRU40 |
| 5 | 52DRU40 | 52DRU40 | 26DRU40 | 52DRU40 | 52DRU40 |
| 6 | 52DRU40 | 52DRU40 | 26DRU40 | 52DRU40 | 52DRU40 |
| 7 | 52DRU40 | 52DRU40 | 26DRU40 | 52DRU40 | 52DRU40 |
| 8 | 52DRU40 | 52DRU40 | 26DRU40 | 52DRU40 | 52DRU40 |

| | | | | |
|---|---|---|---|---|
| 9 | 106DRU40 | 26DRU40 | 52DRU40 | 52DRU40 |

| | | | |
|---|---|---|---|
| 10 | 106DRU40 | 26DRU40 | 106DRU40 |
| 11 | 106DRU40 | 26DRU40 | 106DRU40 |
| 12 | 106DRU40 | 26DRU40 | 106DRU40 |

TABLE 18
Second Part of Another Design of the RU Allocation field in the
UHR-SIG field for DRUs for a Distribution Bandwidth of 40 MHz

| RU | | | | | | | | | |
|---|---|---|---|---|---|---|---|---|---|
| Allocation | | | | | | | | | |
| field | 10 | 15 | 12 | 17 | 14 | 11 | 16 | 13 | 18 |
| 0 | 26DRU40 | 26DRU40 | 26DRU40 | 26DRU40 | 26DRU40 | 26DRU40 | 26DRU40 | 26DRU40 | 26DRU40 |
| 1 | 26DRU40 | 26DRU40 | 26DRU40 | 26DRU40 | 26DRU40 | 26DRU40 | 26DRU40 | 26DRU40 | 26DRU40 |
| 2 | 26DRU40 | 26DRU40 | 26DRU40 | 26DRU40 | 26DRU40 | 26DRU40 | 26DRU40 | 26DRU40 | 26DRU40 |
| 3 | 26DRU40 | 26DRU40 | 26DRU40 | 26DRU40 | 26DRU40 | 26DRU40 | 26DRU40 | 26DRU40 | 26DRU40 |
| 4 | 26DRU40 | 26DRU40 | 26DRU40 | 26DRU40 | 26DRU40 | 26DRU40 | 26DRU40 | 26DRU40 | 26DRU40 |

| | | | | | | | | |
|---|---|---|---|---|---|---|---|---|
| 5 | 52DRU40 | 26DRU40 | 26DRU40 | 26DRU40 | 26DRU40 | 26DRU40 | 26DRU40 | 26DRU40 |

| | | | | | | | |
|---|---|---|---|---|---|---|---|
| 6 | 52DRU40 | 52DRU40 | 26DRU40 | 26DRU40 | 26DRU40 | 26DRU40 | 26DRU40 |

| | | | | | | |
|---|---|---|---|---|---|---|
| 7 | 52DRU40 | 52DRU40 | 26DRU40 | 52DRU40 | 26DRU40 | 26DRU40 |

| | | | | | |
|---|---|---|---|---|---|
| 8 | 52DRU40 | 52DRU40 | 26DRU40 | 52DRU40 | 52DRU40 |
| 9 | 52DRU40 | 52DRU40 | 26DRU40 | 52DRU40 | 52DRU40 |
| 10 | 52DRU40 | 52DRU40 | 26DRU40 | 52DRU40 | 52DRU40 |

| | | | | |
|---|---|---|---|---|
| 11 | 106DRU40 | 26DRU40 | 52DRU40 | 52DRU40 |

| | | | |
|---|---|---|---|
| 12 | 106DRU40 | 26DRU40 | 106DRU40 |

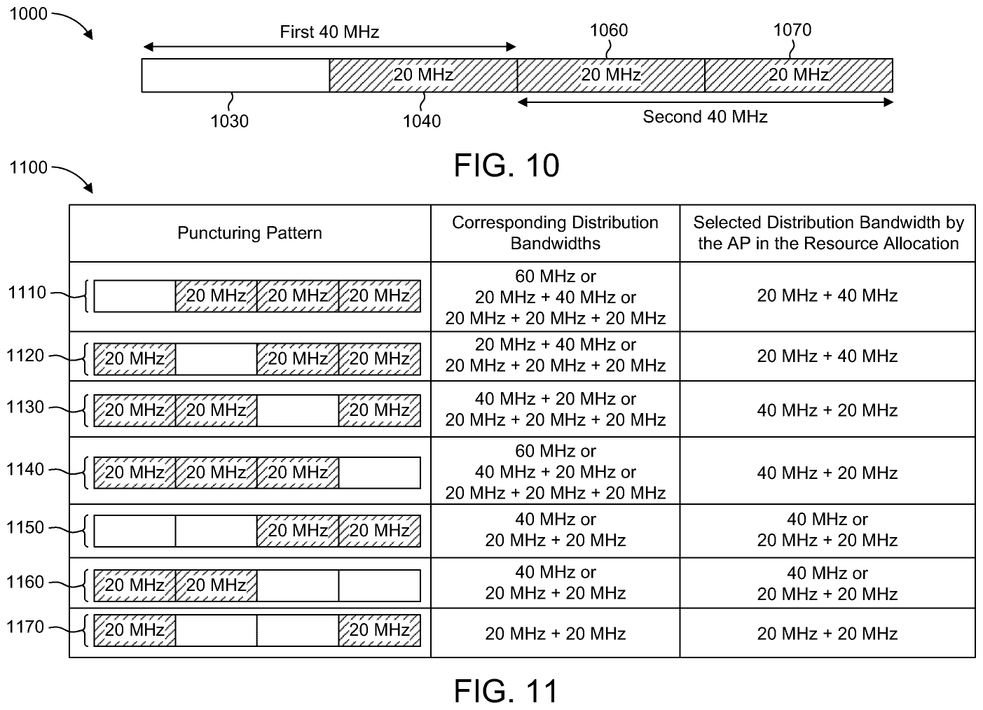

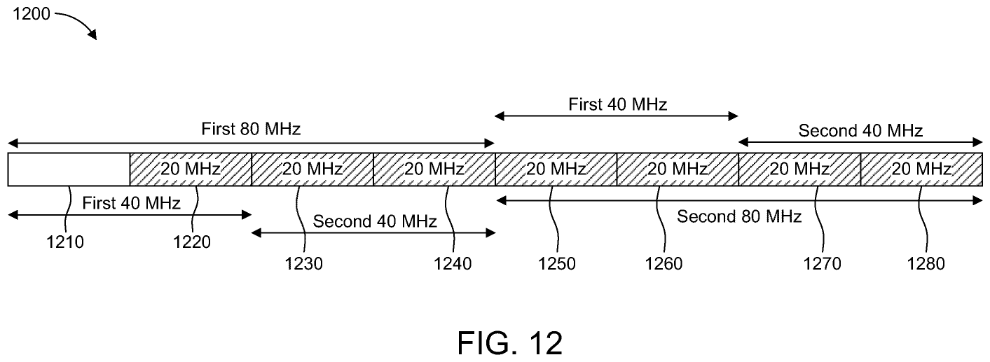

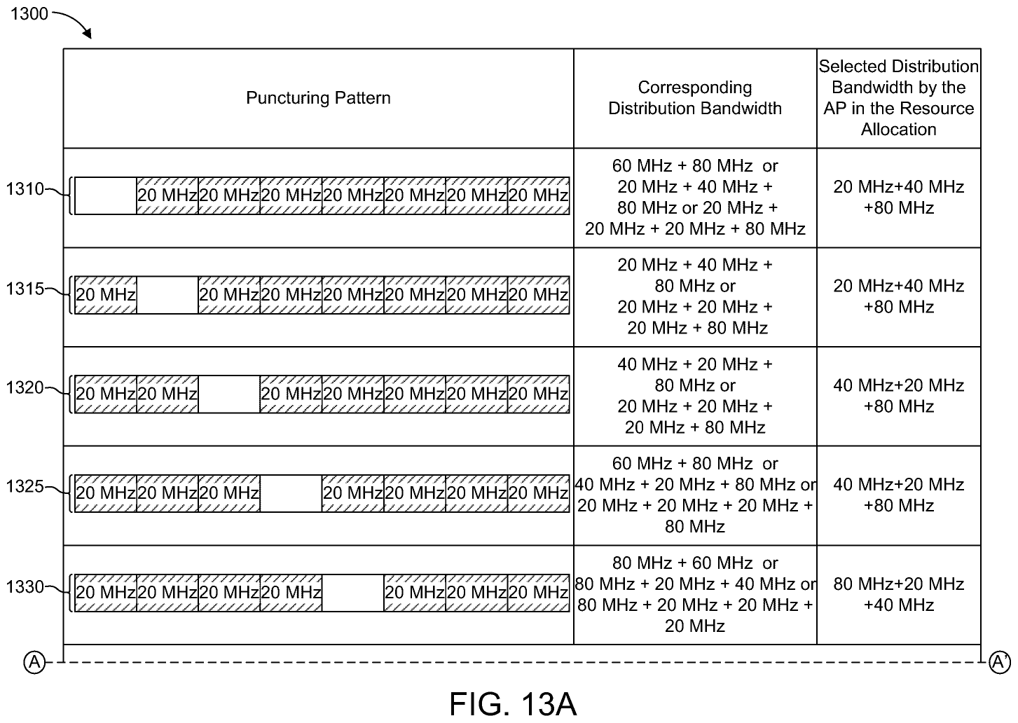

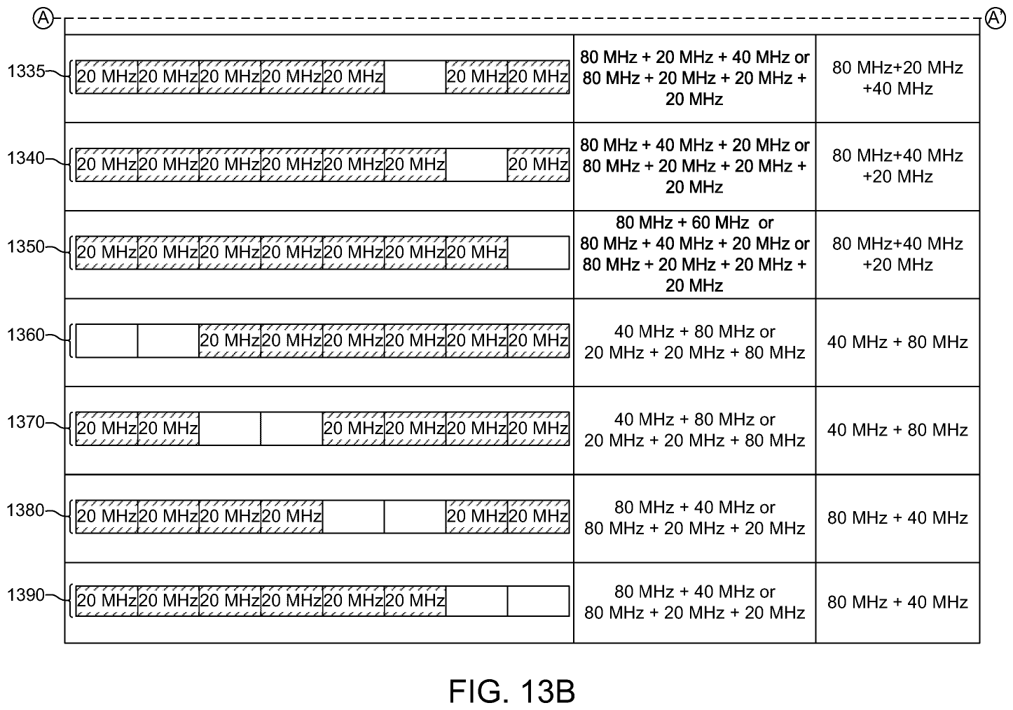

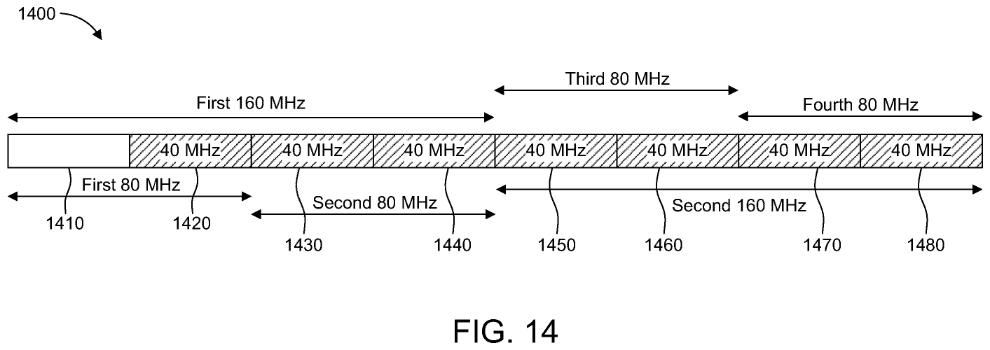

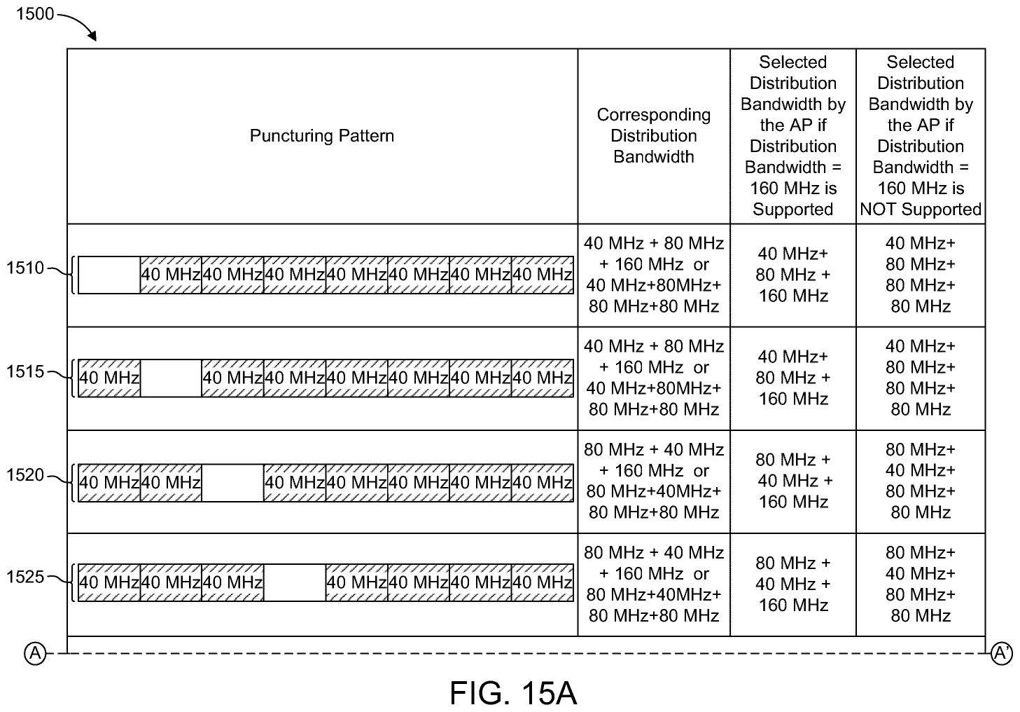

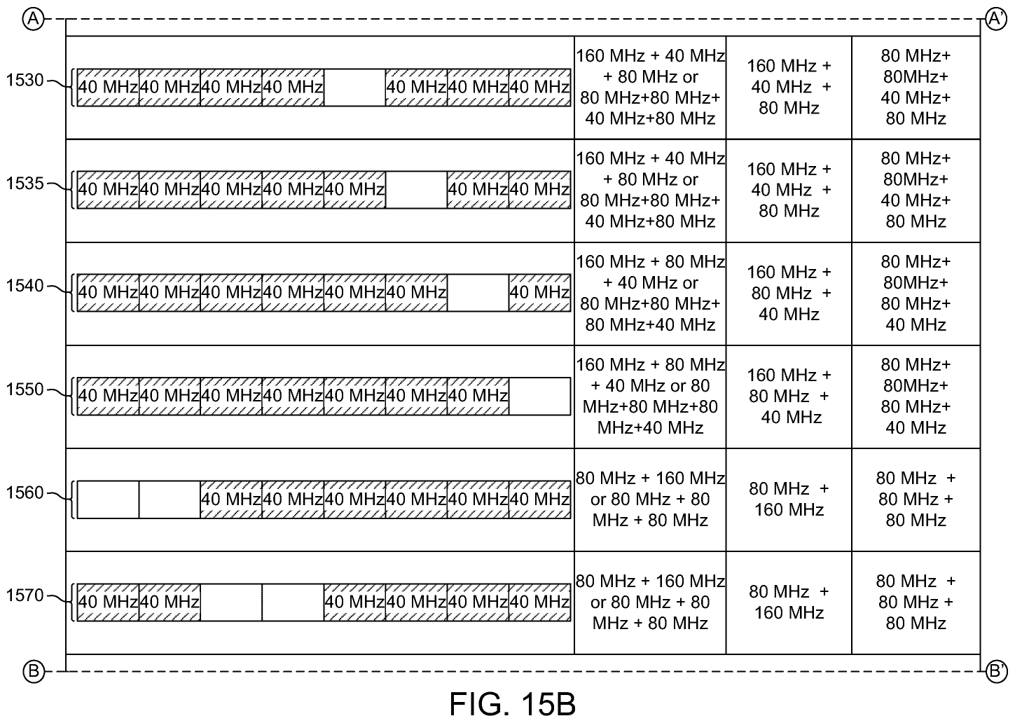

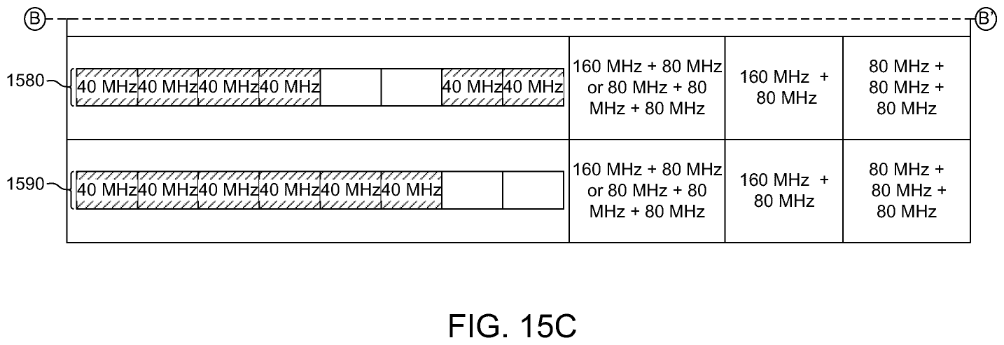

In an example, the AP may allocate one or more DRUs for one or more non-AP STAs to transmit over punctured channels in the uplink using TB PPDUs. The selection of the distribution bandwidth for 80 MHz channels follows the mask as illustrated in FIG. 10 and listed in the table in FIG. 11, as explained further below. Also, the selection of the distribution bandwidth for 160 MHz channels follows the mask as illustrated in FIG. 12 and listed in the table in FIG. 13 (FIG. 13A and FIG. 13B are collectively referred to herein as FIG. 13), as explained further below. Moreover, the selection of the distribution bandwidth for 320 MHz channels follows the mask as illustrated in FIG. 14 and listed in the table in FIG. 15 (FIG. 15A, FIG. 15B, and FIG. 15C are collectively referred to herein as FIG. 15), as explained further below.

In an example, the non-AP STA identifies the allocated DRU to itself in the Trigger frame by identifying the distribution bandwidth corresponding to the puncturing pattern of the BSS channel as listed in the tables in FIG. 11, FIG. 13 and FIG. 15.

In cases where an 80 MHz bandwidth channel is punctured, enabling the DRU in this punctured channel requires the definition or determination of the allowed distribution bandwidths in the remaining unpunctured subchannels.

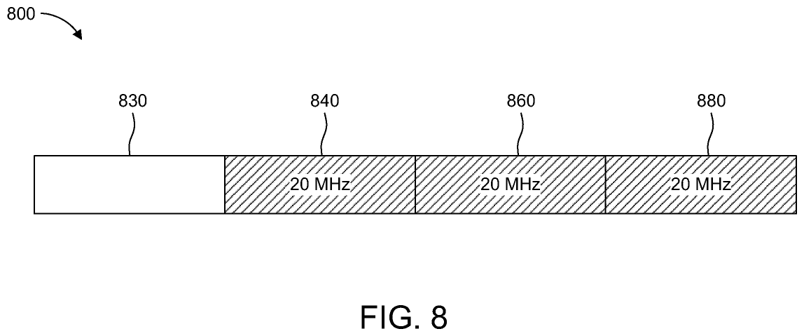

FIG. 8 is a channel diagram illustrating an example of a punctured 80 MHz channel. As shown in an example in channel diagram 800, an 80 MHz channel may include a punctured subchannel 830 and non-punctured subchannels 840, 860, 880. There are multiple options of how to define the distribution bandwidth in the remaining, non-punctured, 60 MHz which may include: 60 MHz distribution bandwidth; 20 MHz distribution bandwidth+40 MHz distribution bandwidth (20+40); 40 MHz distribution bandwidth+20 MHz distribution bandwidth (40+20); and 20 MHz distribution bandwidth+20 MHz distribution bandwidth+20 MHz distribution bandwidth (20+20+20).

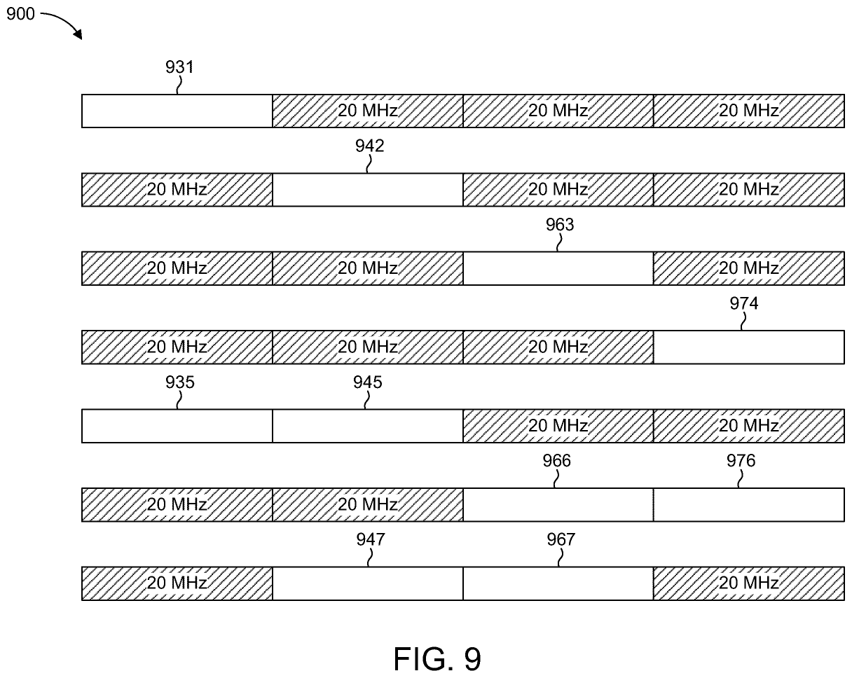

FIG. 9 is a channel diagram illustrating an example of all combinations of a punctured 80 MHz channel. In an example, the 80 MHz channel may be used in 802.11be. In other examples, the 80 MHz channel may be used in other versions of Wi-Fi communication or in other forms of wireless communication. As shown in an example in channel diagram 900, available options to use the distribution bandwidth may include: non-punctured subchannels of 20 MHz each, after punctured subchannel 931; a non-punctured subchannel of 20 MHZ, followed by a punctured subchannel 942, which is then followed by two non-punctured subchannels of 20 MHz each; two non-punctured subchannels of 20 MHz each, followed by a punctured subchannel 963, which is then followed by a non-punctured subchannel of 20 MHz; three non-punctured subchannels of 20 MHz each, followed by a punctured subchannel 974; two punctured subchannels 935, 945, followed by two non-punctured subchannels of 20 MHz each; two non-punctured subchannels of 20 MHz each, followed by two punctured subchannels 966, 976; and a non-punctured subchannels of 20 MHZ, followed by two punctured subchannel 947, 967, which are then followed by a non-punctured subchannel of 20 MHz. Further, considering all the defined puncturing patterns, the available options to define the distribution bandwidth may include: 20 MHz+20 MHz+20 MHz; 20 MHz+40 MHz; 40 MHz+20 MHz; 40 MHz; 20 MHz+20 MHz; and 60 MHz.

FIG. 10 is a channel diagram illustrating an example of a determination of the distribution bandwidth in a punctured 80 MHz channel. As shown in an example in channel diagram 1000, a punctured subchannel 1030 may be followed by three 20 MHz non-punctured subchannels 1040, 1060, 1070. Further, punctured subchannel 1030 and non-punctured subchannel 1040 may be located in a first 40 MHz of bandwidth and non-punctured subchannels 1060, 1070 may be located in a second 40 MHz of bandwidth.

Further, the distribution bandwidth in a punctured 80 MHz channel may be determined by applying a mask which is composed of two non-overlapping 40 MHz subchannels, shown as the first 40 MHz and the second 40 MHz in an example shown in FIG. 10. The mask determines the distribution bandwidth by excluding the punctured subchannel 1030 from the corresponding component 40 MHz subchannel. In one example shown in FIG. 10, the distribution bandwidth in this puncturing pattern is 20 MHz+40 MHz.

FIG. 11 is a table diagram listing an example of the corresponding distribution bandwidths for different puncturing patterns in an 80 MHz channel. Following the mask in FIG. 10, the AP may select a certain distribution bandwidth in the resource allocation of different DRUs to different STAs as indicated in the table in FIG. 11. In an example shown in table diagram 1100, the table lists all the corresponding distribution bandwidths for different puncturing patterns 1110, 1120, 1130, 1140, 1150, 1160, 1170 in the 80 MHz channel.

FIG. 12 is a channel diagram illustrating an example of a determination of the distribution bandwidth in a punctured 160 MHz channel. As shown in an example in channel diagram 1200, a punctured subchannel 1210 may be followed by seven 20 MHz non-punctured subchannels 1220, 1230, 1240, 1250, 1260, 1270, 1280. Further, punctured subchannel 1210 and non-punctured subchannel 1220 may be located in a first 40 MHz of bandwidth of a first 80 MHz bandwidth segment, and non-punctured subchannels 1230, 1240 may be located in a second 40 MHz of bandwidth of the first 80 MHz bandwidth segment. Also, non-punctured subchannels 1250, 1260 may be located in a first 40 MHz of bandwidth of a second 80 MHz bandwidth segment, and non-punctured subchannels 1270, 1280 may be located in a second 40 MHz of bandwidth of the second 80 MHz bandwidth segment.

Further, the distribution bandwidth in a punctured 160 MHz channel may be determined by applying a mask which is composed of two non-overlapping 80 MHz subchannels, shown as the first 80 MHz bandwidth segment and the second 80 MHz bandwidth segment in an example shown in FIG. 12. The mask determines the distribution bandwidth by excluding the punctured subchannel 1210 from the corresponding component 80 MHz subchannel. The distribution bandwidth of each of the 80 MHz segments of the 160 MHz channel can be then determined in a similar way as described in the above example. In one example shown in FIG. 12, the distribution bandwidth in this puncturing pattern is 20 MHZ+40 MHz+80 MHz.

In an example, a non-punctured 80 MHz channel or the 80 MHz segment with no puncturing in a punctured 160 MHz channel (for example, the second 80 MHz in FIG. 12) or an 80 MHz segment with no puncturing in a punctured 320 MHz channel may be used as an 80 MHz distribution bandwidth or it may include other distribution bandwidths such as (40 MHZ+40 MHZ) or (20 MHZ+20 MHz+40 MHZ) or (20 MHz+40 MHZ+20 MHz) or (40 MHz+20 MHZ+20 MHZ) or (20 MHz+20 MHz+20 MHz+20 MHZ).

FIG. 13 is a table diagram listing an example of the corresponding distribution bandwidths for different puncturing patterns in a 160 MHz channel. Following the mask in FIG. 12, the AP may select a certain distribution bandwidth in the resource allocation of different DRUs to different STAs as indicated in the table in FIG. 13A and FIG. 13B (collectively, FIG. 13). In an example shown in table diagram 1300, the table lists all the corresponding distribution bandwidths for different puncturing patterns 1310, 1315, 1320, 1325, 1330, 1335, 1340, 1350, 1360, 1370, 1380, 1390 in the 160 MHz channel.

FIG. 14 is a channel diagram illustrating an example of a determination of the distribution bandwidth in a punctured 320 MHz channel. As shown in an example in channel diagram 1400, a punctured subchannel 1410 may be followed by seven 40 MHz non-punctured subchannels 1420, 1430, 1440, 1450, 1460, 1470, 1480. Further, punctured subchannel 1410 and non-punctured subchannel 1420 may be located in a first 80 MHz bandwidth segment of a first 160 MHz bandwidth segment, and non-punctured subchannels 1430, 1440 may be located in a second 40 MHz bandwidth segment of the first 160 MHz bandwidth segment. Also, non-punctured subchannels 1450, 1460 may be located in a third 40 MHz bandwidth segment within a second 80 MHz bandwidth segment, and non-punctured subchannels 1470, 1480 may be located in a fourth 40 MHz bandwidth segment of the second 160 MHz bandwidth segment.

FIG. 15 is a table diagram listing an example of the corresponding distribution bandwidths for different puncturing patterns in a 320 MHz channel. Following the mask in FIG. 14, the AP may select a certain distribution bandwidth in the resource allocation of different DRUs to different STAs as indicated in the table in FIG. 15A, FIG. 15B and FIG. 15C (collectively, FIG. 15). In an example shown in table diagram 1300, the table lists all the corresponding distribution bandwidths for different puncturing patterns 1510, 1515, 1520, 1525, 1530, 1535, 1540, 1550, 1560, 1570, 1580, 1590 in the 320 MHz channel.

In an example, a non-punctured 160 MHz channel or the 160 MHz segment with no puncturing in a punctured 320 MHz channel (for example, the second 160 MHz in FIG. 14) may be used as a 160 MHz distribution bandwidth, or it may include other distribution bandwidths such as (80 MHZ+80 MHZ) or any combination of distribution bandwidths in an 80 MHz channel for one of the 80 MHz segments of this 160 MHz channel or both of them.

Further, the reference to a distribution bandwidth 60 MHz may refer to using the entire channel bandwidth as a distribution bandwidth with different DRU sizes spread over this distribution bandwidth. Also, the reference to distribution bandwidths 20 MHz+40 MHz may refer to splitting the channel bandwidth into two separate distribution bandwidths with different DRU sizes spread over the different distribution bandwidths. Moreover, the listed puncturing patterns in this description are examples. All the rules may apply to any other puncturing pattern which is not listed in the above tables.

Examples are provided herein of rule for choosing the distribution bandwidth. The following rules may be applied to simplify determining the distribution bandwidth in each channel bandwidth. In a 20 MHz channel, the distribution bandwidth is 20 MHz. In a 40 MHz channel, the distribution bandwidth is 40 MHz. In a non-punctured 80 MHz channel, the distribution bandwidth is 80 MHz. In a punctured 80 MHz channel, the distribution bandwidths follow the mask in FIG. 10 such that the distribution bandwidth is either (20 MHz+40 MHZ) or (40 MHZ+20 MHZ) according to the puncturing pattern.

In a non-punctured 160 MHz channel, the distribution bandwidth is 160 MHz or (80 MHz+80 MHZ). In a punctured 160 MHz channel, the distribution bandwidths follow the mask in FIG. 12 such that the distribution bandwidth is either (20 MHz+40 MHZ) or (40 MHZ+20 MHZ) in the punctured 80 MHz segment and the distribution bandwidth is 80 MHz in the non-punctured 80 MHz segment according to the puncturing pattern.

In a non-punctured 320 MHz channel, the distribution bandwidth is either 320 MHz or (160 MHZ+160 MHZ) or (80 MHz+80 MHz+80 MHz+80 MHZ). In a punctured 320 MHz channel, the distribution bandwidths follow the mask in FIG. 14 such that the distribution bandwidth is either (20 MHz+40 MHZ) or (40 MHz+20 MHZ) in the punctured 80 MHZ segments and the distribution bandwidth is either 80 MHz in the non-punctured 80 MHz segments or 160 MHz in the non-punctured 160 MHz segments according to the puncturing pattern.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A station (STA) comprising:
a transceiver; and
a processor operatively coupled to the transceiver, wherein:
the transceiver and the processor are configured to receive, from an access point (AP), a trigger frame including a resource unit (RU) allocation field indicating a distributed RU (DRU) index value;
the processor is configured to determine, based on the indicated DRU index value, a DRU allocation from a plurality of DRU allocations, wherein each of the plurality of DRU allocations includes a respective tone distribution plan, and wherein tones of the determined DRU allocation and the respective tone distribution plan are interleaved with tones of one or more other tone distribution plans, of the plurality of tone distribution plans, across a distribution bandwidth; and
the transceiver and the processor are configured to transmit, to the AP, based on the determined DRU allocation and respective tone distribution plan, a plurality tones using a DRU within the distribution bandwidth.

2. The STA of claim 1, wherein the trigger frame further includes indication information indicating the distribution bandwidth.

3. The STA of claim 2, wherein the determination is further based on the indicated distribution bandwidth.

4. The STA of claim 1, wherein the plurality of tones are transmitted over a plurality of RUs.

5. The STA of claim 1, wherein the determined DRU allocation further includes the distribution bandwidth.

6. The STA of claim 1, wherein the determined DRU allocation and subcarrier tone distribution plan further includes a distribution of tones in regions outside of punctured subchannels within a channel.

7. The STA of claim 1, wherein the RU allocation field is received in a User Info field of the trigger frame.

8. The STA of claim 1, wherein the RU allocation field is received in a ultra-high reliability (UHR)-SIG field of a physical layer (PHY) protocol data unit (PDU) (PPDU).

9. The STA of claim 1, wherein the RU Allocation field is received in a Control Information sub-field in a triggered response scheduling (TRS) Control field of a PPDU.

10. The STA of claim 1, wherein a DRU size is determined based on at least one of the RU allocation field or the indicated DRU index value; and wherein the DRU allocation is further determined based on the DRU size.

11. A method for use in a station (STA), the method comprising:
receiving, from an access point (AP), a trigger frame including a resource unit (RU) allocation field indicating a distributed RU (DRU) index value;
determining, based on the indicated DRU index value, a DRU allocation from a plurality of DRU allocations, wherein each of the plurality of DRU allocations includes a respective tone distribution plan, and wherein tones of the determined DRU allocation and the respective tone distribution plan are interleaved with tones of one or more other tone distribution plans, of the plurality of tone distribution plans, across a distribution bandwidth; and
transmitting, to the AP, based on the determined DRU allocation and respective tone distribution plan, a plurality tones using a DRU within the distribution bandwidth.

12. The method of claim 11, wherein the trigger frame further includes indication information indicating the distribution bandwidth.

13. The method of claim 12, wherein the determination is further based on the indicated distribution bandwidth.

14. The method of claim 11, wherein the plurality of tones are transmitted over a plurality of RUs.

15. The method of claim 11, wherein the determined DRU allocation further includes the distribution bandwidth.

16. The method of claim 11, wherein the determined DRU allocation and subcarrier tone distribution plan further includes a distribution of tones in regions outside of punctured subchannels within a channel.

17. The method of claim 11, wherein the RU allocation field is received in a User Info field of the trigger frame.

18. The method of claim 11, wherein the RU allocation field is received in a ultra-high reliability (UHR)-SIG field of a physical layer (PHY) protocol data unit (PDU) (PPDU).

19. The method of claim 11, wherein the RU Allocation field is received in a Control Information sub-field in a triggered response scheduling (TRS) Control field of a PPDU.

20. The method of claim 11, wherein a DRU size is determined based on at least one of the RU allocation field or the indicated DRU index value; and wherein the DRU allocation is further determined based on the DRU size.
